(19) United States
(12) Patent Application Publication
(10) Pub. No.: US 2006/0247968 A1
(43) Pub. Date: Nov. 2, 2006

(54) Systems and methods for marketing health products and/or services to health consumers and health providers

(76) Inventor: Bassam Kadry, Chicago, IL (US)

Correspondence Address: MCANDREWS HELD & MALLOY, LTD, 500 WEST MADISON STREET, SUITE 3400, CHICAGO, IL, 60661, US

(21) Appl. No.: 11/120,837

(22) Filed: May 2, 2005

(51) Int. Cl. G07G 1/14; G06Q 10/00; G07G 1/00

(52) U.S. Cl. 705/14; 705/2; 705/10

(57) ABSTRACT

The present systems and methods relate to marketing health products and health services. One or more marketing presentations are made to a health consumer about one or more health products or health services. The marketing presentations are targeted based on health data regarding the health consumer and optionally data regarding the health provider. The present systems and methods allow life science companies, government entities and others to more efficiently and effectively market health products and/or health services to health consumers and health providers.

### FIELD OF THE INVENTION

The present systems and methods relate to marketing health products and health services. One or more marketing presentations are made to a health consumer about one or more health products or health services. The marketing presentations are targeted based on health data regarding the health consumer and optionally data regarding the health provider. The present systems and methods allow life science companies, government entities and others to more efficiently and effectively market health products and/or health services to health consumers and health providers.

### BACKGROUND OF THE INVENTION

When a patient goes to see a doctor or other health provider, the visit generally includes an exchange of information between the patient and doctor. The health consumer provides the reason for his or her visit, that is, the symptoms or conditions causing the health consumer to seek help. But the flow of information is not one way; the health consumer also receives information from the health provider. In the course of such a visit, it may be desirable to provide a presentation about a medical or other health-related subject. For example, it may be desirable to provide a presentation to the patient and possibly other interested persons (e.g., family members, friends) about a medical condition that the patient has. In this way, those persons can be informed about the causes, remedies, and lifestyle changes related to the medical condition.

Traditionally, a health-care professional, such as a physician or a nurse, discusses health issues with the patient and his/her family. These discussions are typically oral, though they may be supplemented with pamphlets, brochures, or other printed material, often provided by suppliers of drugs and other products. Physicians are often rushed and may not provide information to the satisfaction of the patient. Some patients may not have the foundation of knowledge to construct a question that the physician can answer to the patient's satisfaction. Physicians are often rushed and would benefit from having a way to efficiently and accurately provide answers to frequently asked questions, as opposed to repeating themselves each time.

As mentioned, a patient visiting a doctor's office may receive a printed pamphlet or brochure, or a video cassette, CD, or DVD presentation. However, pamphlets and brochures have limitations with regard to the amount of information they are able to contain and convey. The media elements used in the presentation are typically limited to a few still images and relatively short text. Similarly, video cassette presentations are also limited with regard to interactivity and ability to navigate the presentation. CDs and DVDs are limited in that they must be physically delivered and there is little or no means of targeting the content of the CD or DVD or for the physician to modify the content.

Life science companies develop and market numerous health products and services which can improve health consumers' conditions and quality of life. In general, it takes significant expenditures to develop and market a health product such as a prescription medication. Large sums are devoted to marketing and advertising, which includes informing physicians and the public about those health products and services. In fact, more money is used marketing and advertising drugs than is invested in research and development. In 2002, roughly $25 billion was spent on marketing and advertising medications in the US alone. Fairly recently, life science companies have begun to employ direct-to-consumer advertisements, such as TV ads, magazine ads, radio ads, and others to reach large audiences in which most members are not even candidates for therapies they provide.

Physicians have a large role in determining whether prescription medications and many other health products are to be provided to patients. Marketing campaigns for products and/or services should be effective in informing a physician and affecting a physician's decision. Accordingly, life science companies invest large sums per year in marketing to individual physicians.

Efforts to inform physicians about health products and services are made more difficult by the regulatory and market pressures placed on physicians. Physicians face increased economic pressure to see more health consumers in less time. The high cost of medical malpractice, as well as increases in bureaucratic paper work and legal regulations, have forced physicians to not only meet the scientific and intellectual demands of being a physician, but also to perform tasks they have not been traditionally trained for. Such additional skills are especially challenging and demanding when taking time to inform health consumers about health products. Physicians could greatly benefit from technologies that enhance the patient's experience by adopting an easier, more efficient, more reliable, and/or more understandable means of exchanging information.

Another issue relating to marketing and access by life science companies to health consumer information involved privacy regulations such as the Health Insurance Portability and Accountability Act of 1996 (“HIPAA”). HIPAA guidelines were created to help preserve patient privacy. Healthcare providers have undertaken significant efforts to avoid disclosure of protected patient information to individuals not involved in the care of health consumers. The healthcare industry as a whole has spent billions of dollars to become HIPAA compliant. For example, computers now have monitors with polarized screens. Very elaborate login systems have been developed differentiating between physicians, nurses, technicians, and administrators to ensure that any information is given only to the appropriate caretaker.

Due to the aforementioned problems and disadvantages in the prior art, a need exists for improved technologies for providing information about health products and health services to patients, in a way which doctors are comfortable. Furthermore, in view of the time demands placed on doctors (and many patients as well), a need exists for leveraging the time that patients spend waiting to be evaluated by doctors and nurses.

Systems and methods for educating health consumers have been proposed in the prior art. For example, U.S. Patent Application Publication No. 2004/0023198 A1 discusses a system, method, and computer program for providing a multi-media education and disclosure presentation on a medical or other health-related subject to a health consumer or other interested persons. The system may be fixed or portable in nature and broadly includes a touchscreen for communicating the presentation and facilitating input; a plurality of wheels to enhance portability; a printer to print a consent form following the presentation; and an adjustable boom for positioning the touchscreen for comfortable viewing by the health consumer. The presentation broadly comprises a background section; a condition section; a remedy section; and a lifestyle section, and each such section is represented by one or more detailed topic pages. The presentation incorporates a variety of media elements, such as video, audio, still images, and text, and images or sound taken -from diagnostic medical equipment.

U.S. Patent Application Publication No. 2003/0022141 A1 discusses a method and system for educating patients and consumers in medical and health information. In the preferred embodiments, the system and method presents an interactive presentation of medical and health information to a subject, tests the subject in the presented medical and health information, provides Health Maintenance Organizations (HMOs) and health insurance companies with relevant statistics and information concerning individual patient's and patient groups, and provides doctors with feedback concerning patient knowledge and understanding of the medical and health information.

Systems and methods have also been proposed for facilitating the collection of medical information. U.S. Patent Application Publication No. 2004/0138924 A1 discusses a system and method for intake of medical patients to emergency rooms at hospitals. An embodiment includes a kiosk with an audio assisted touch screen that presents a number of intake questions to a patient in their preferred language to automate the repetitive component of the interviews. In response to the questions, the kiosk generates an intake report for presentation to a health care worker such as a doctor or a nurse to create a jump-start for the live interview. In this manner, waiting times at hospital emergency rooms can be used to initiate the health consumer care, even before they see the health care staff, safely since the application can also streamline the waiting room population and save time for all involved parties including the patients, nurses, the physicians and the health care facility. The application has desktop and web versions. The interview is customizable at every level for the questions, flow and language. The suggested consistent and methodical screening for all system/organs and documentation of the interview's findings helps to reduce physician errors and provides a malpractice shield.

U.S. Patent Application Publication No. 2002/0035486 A1 discusses a clinical questionnaire system and method that presents medical questions to a subject and determines additional questions to present based on the subject's response to previous questions. Positive responses to primary questions trigger presentation of secondary and lower-level questions requesting more specific information from the subject. Deeper-level questions follow a medical pathway correlated with a known medical condition and can prompt presentation of clinical warnings.

There are various systems and methods for life science industries to market their products. For example, International Publication No. WO 00/57976 discusses a system and method for interactive marketing in the life sciences industries. Targeted respondent data for a client company project is input to a system server which is used to generate survey participation offers. The system server transmits the participation offers having a project identifier and respondent identifier to the respondents on an automated basis such as by facsimile transmission. When a survey participant responds, the system server conducts an automated survey either by telephone or by electronic form using predetermined survey questions for the client company marketing project. An audio or audiovisual marketing message is selected and played to the survey participant based on either the participant's responses to the selected survey questions or other profile data of the participant. The survey responses are recorded and the response data, or processed statistical reports generated from the response data, are transmitted to the client company. The response data and statistical reports may be generated and accessed on a real-time basis by the client company via a telecommunications link to the system server. Optionally, the system server generates and transmits a reward to survey participants.

U.S. Patent Application Publication No. 2002/0065683 A1 discusses a system that provides a web site through which physicians can access information about multiple drugs provided by multiple drug companies. A user is authenticated as being a registered physician before being allowed access to the system. The system provides an interactive on-line detail or marketing presentation of a drug. The interactive detail provides information about a drug in addition to requesting and receiving responses or input from the user participating in the interactive detail. Questions and challenges are presented to the user to reinforce concepts, such as a drug's mechanism of action, that are presented to the user during the detail. Users' responses to interactive details are accumulated and provided to the respective drug companies that sponsor the details. As an incentive, the system provides an honorarium or gift to targeted users upon completion of interactive presentations.

There are various systems and methods for life science companies to determine (or try to determine) the results of their advertising efforts. For example, U.S. Patent Application Publication No. 2004/0049506 A1 discusses a system and method for electronic and algorithmic data mining of an individual physician's prescribing history to determine the approximate distribution of diseases within their practice population for optimizing pharmaceutical sales and marketing.

As another example, U.S. Patent Application Publication No. 2004/0122726 A1 discusses a method for evaluating the sales performance regarding at least one product. The method comprises: storing, in a central database, data related to the identities of a plurality of marketing representatives being associated with the product; storing, in the database, collected data related to at least one key success factor associated with the market performance related to the product as a result of marketing activities of the plurality of marketing representatives with respect to a number of customers of the product; and transmitting and presenting the information to at least one external user. The method allows improved monitoring and evaluation of the effectiveness of a marketing or sales staff of a company.

There remains a need for a better, more efficient marketing channel for health products and/or health services. There also is a need for a better tool for measuring the effect of marketing. There is also a need for ways to leverage or better use the time spent by health consumers waiting to be evaluated by a health practitioner. There is also a need for better options for health consumers to shop for and purchase health products and/or health services. There is also a need for a marketing channel for government entities and others to market health products and/or services, including generic medications. There is also a need for life science companies to efficiently and accurately determine the results of their advertising efforts on prescriptions and/or purchases. These and other needs can be met by the use of various embodiments of the present invention.

### SUMMARY OF THE INVENTION

As one aspect of the present invention, methods and systems are disclosed for providing one or more marketing presentations about health products and/or health services to health consumers. The methods and systems can provide a health provider with the ability to approve and/or customize marketing presentations before they are presented to health consumers under that health provider's care. Health data is obtained from the health consumer, and one or more marketing presentations about health products and/or health services are selected based on the health data and/or data regarding the health provider (health provider data) and targeted to the health consumer. In this way, it is possible to provide targeted authenticated content (marketing presentations) to the health consumer and health provider. Other features of the present methods and systems can include assigning a tracking code to the health consumer, associating a marketing presentation presented to the health consumer with the tracking code, obtaining prescription information or purchase information for the health consumer, and associating the prescription or purchase information with the tracking code. The marketing presentation and the prescription or purchase information can be compared to determine whether there is a correlation between the marketing presentation and the prescription and/or purchase. A prescription or a request to purchase a health product or service can be transmitted to a pharmacy or other vendor of health products or services. The transmission of the prescription or request to a pharmacy or vendor can be tracked, and/or a price for a prescription medicine or other product or service can be obtained from one or more pharmacies or vendors. The present systems and methods may include various means or modules for performing one or more of the foregoing functions.

As another aspect of the present invention, systems and methods are provided for presenting one or more targeted marketing presentations about health products or health services in an electronic format to a health consumer, preferably while he or she is awaiting evaluation from a health practitioner. The systems and methods can include a health consumer interview module configured to obtain health data from a health consumer; a selection module configured to select one or more marketing presentation(s) for the health consumer based on the health data and/or health provider data; and a presentation module configured to present the selected marketing presentation. The systems and methods can also include a content provider module configured to give access to a marketing presentation database or the selection module to an authorized content provider, wherein the authorized content provider can add, adjust, or remove the marketing presentation; and a health provider approval module configured to give a health provider approval over a marketing presentation before that marketing presentation is available to the health consumer.

The systems and methods can also include a tracking module configured to associate each viewing of a marketing presentation by a health consumer with a tracking code. Preferably the tracking code does not include information which personally identifies the health consumer. The systems and methods can also include a reporting module configured to report tracking codes and associated information to a system administrator or an authorized content provider, preferably without reporting information that personally identifies the health consumer. The system can also include a health product or service request module, and the tracking module can be configured to associate a health product or service request with the tracking code. For example, the systems and methods can include a prescription request module, and the tracking module can be configured to associate prescription information or purchase information with the tracking code. The present systems and methods may include various means or software for performing one or more of the foregoing functions.

As yet another aspect, systems and methods are disclosed for providing marketing presentations about health products or health services in an electronic format to a health consumer, preferably while the health consumer is awaiting evaluation by a health practitioner. Computer software is adapted to obtain health data, select one or more marketing presentations based on the obtained health data, and provide the selected marketing presentation in an electronic format. A computer is adapted for running the computer software and to communicate a visual and/or audio component of the marketing presentation. The systems and methods can also include a printer adapted for communication with the computer and for printing a record containing the health data obtained from the health consumer.

As another aspect, systems and methods are provided for collecting information regarding prescriptions. A tracking code is assigned to a health consumer. The health consumer is shown one or more marketing presentations for health products or health services. The marketing presentation(s) shown to the health consumer are associated with the tracking code. A determination is made whether the health consumer purchased a health product or health service or received a prescription, thereby obtaining purchase information or prescription information. One or both of the purchase information and the prescription information are associated with the tracking code. Also one or more health conditions or other health data of the health consumer (but preferably not personal information) or health provider data can be associated with the tracking code. The tracking code and associated data and information can be provided (in compliance with legal regulations and appropriate standards) to government entities, life science companies, and other content providers.

As a further aspect, a health marketing system provides a health consumer and a health provider with one or more marketing presentations about health products or health services. The system comprises a central server configured to store marketing presentations about health products or health services; one or more local servers configured to communicate with the central server; a health consumer interface configured to communicate with the local server; a health provider interface configured to permit adjustment of the health consumer interface; and a content provider interface that permits a content provider to add, remove, or adjust the marketing presentations for the health consumer interface. The health consumer interface is adapted to obtain health data and to provide marketing presentations. The local server is configured to receive health data from the health consumer interface and to select one or more marketing presentations about health products or health services based on the health data. The health consumer interface is adapted to present the selected marketing presentations in an electronic format. The content provider interface is adapted to provide associations between the marketing presentations and health provider data or health data, including but not limited to health conditions; symptoms; medications previously taken by the health consumer; prescriptions written by the health provider to the health consumer; prescriptions (or other health products or services) purchased by the health consumer (such as through the health consumer interface); and/or other data or information.

The present systems and methods can further include, as another aspect of the present invention, means for government entities to rapidly and efficiently communicate with health providers and health consumers, such as in the event of a health product recall or warning, by providing marketing presentations about recalled products or warnings about products.

As yet another aspect of the present invention, government entities and others are enabled to efficiently target health providers and health consumers with marketing presentations about generic health products and health services. In this manner, the present symptoms and methods can help inform health consumers and health providers regarding the availability and efficacy of generic health products and health services.

The present systems and methods can include numerous other features as described in more detail below. For example, the present systems and methods can include the capability to communicate with health consumers of various languages using an automatic translating feature (for example, a translating module included in a computerized system). The systems and methods can include translating, or software for translating, from a first language (for example, English) to a second language (for example, Spanish or another language). The systems and methods can include the capability to translating interview questions, health data, marketing presentations, prescription information, and/or other data or information.

The present systems and methods can be, and are likely to be, tailored to meet the legal regulations of the governing jurisdiction in which the health consumer and/or health provider reside. For example, the present methods and systems can include modifying targeting criteria based on geography to comply with local regulations. As another example, the present methods and systems can include restricting the availability of health data to personnel authorized by the health consumer, and/or preventing access by content providers and others to health data they are not authorized to receive, especially personal information of the health consumer.

### BRIEF DESCRIPTION OF SEVERAL VIEWS OF THE DRAWINGS

FIG. 1 shows various marketing channels that may be employed by life science companies.

FIG. 2 shows the preferred interfaces that may be included in the present systems and methods.

FIG. 3 shows an exemplary network and how various hardware components relate to the network.

FIG. 4 shows various features of a content provider interface for providers of marketing presentations.

FIG. 5 shows sources of content and that content from various providers can be authenticated.

FIG. 6 shows a screenshot from a content provider interface.

FIG. 7 is a diagram of various relationships in providing and viewing content (marketing presentations).

FIG. 8 shows various features of a health provider interface.

FIG. 9 illustrates a form builder interface.

FIG. 10 shows an example screenshot of the form builder interface with a tree menu.

FIG. 11 shows an example screenshot illustrating question editing.

FIG. 12 illustrates a health provider form template library.

FIG. 13 shows various features of a health consumer interface.

FIG. 14 shows an example screenshot of a health consumer interface.

FIG. 15 shows a screen of the health consumer interface configured for identifying medications.

FIG. 16 shows an example of a health data summary.

FIG. 17 shows features of a pharmacy vendor interface.

FIG. 18 shows interaction between the present systems and methods with an Rx vendor.

FIG. 19 illustrates the output of a drug (Rx) shopping price-bot.

FIG. 20 shows an exemplary network diagram for implementing the present systems and methods.

FIG. 21 illustrates the present systems and methods in an out-patient setting.

FIG. 22 shows the use of the present systems and methods in an in-patient setting.

FIG. 23 illustrates the interaction of the present systems and methods with an in-patient system.

FIG. 24 illustrates that the present systems and methods can be used to measure the efficacy of marketing presentations.

### DETAILED DESCRIPTION OF THE INVENTION

The present systems and methods can provide for improved and beneficial marketing of health products and health services by providing a health consumer and a health provider with the same marketing presentation about a health product or service, thereby creating a shared knowledge base regarding the health product or service. The marketing presentation may be targeted to a health provider(s), a health practitioner(s), a health consumer(s), or all of the above. Health providers will like the present systems and methods because they provide health providers with the ability to approve a marketing presentation before it is presented to the health consumer.

Health practitioners provide valuable service and advice through their ability to process raw data and come up with an assessment and treatment plan. The present systems and methods facilitate the collection of health data. For example, by knowing what medications and/or what specialists a health consumer sees, a health practitioner can quickly obtain a reasonable idea of what conditions the health consumer has. The present methods and systems need not replace the investigative work of the health practitioner, but rather complement and facilitate that work. The present systems and methods efficiently collect vital information that will optimize or facilitate the health practitioner's investigative process and ultimately enhance the practitioner/consumer experience.

The present systems and methods can also fill gaps in health consumer knowledge that physicians may not have time or opportunity to provide. Health consumers can obtain information about prescription medicines and other health products and services. Despite physicians' efforts to get their patients to take a medicine, many physicians fail to mention what the medicine is actually intended to do. The magnitude of the unsatisfied demand for information about prescription medicines is apparent in the difference between the number of health consumers seeking specific kinds of information and the number who perceive their doctor gives them the information. This information includes serious, moderate, mild risks of the drug. Others are concerned about drug-to-drug interactions. Some health consumers would like to know the mechanism of action. Although the number of health consumers interested in how medicines will work in their body is lower than the number concerned about side effects or drug-to-drug interactions, this knowledge is often neglected. Several studies have shown that when health consumers know how a medicine works, it tends to improve compliance.

The present systems and methods are useful for (among other things) providing one or more marketing presentations about health-related subjects (such as health products or health services) in an electronic format to a health consumer, such as while the health consumer awaits evaluation from or consultation with a health practitioner. The present systems and methods can be used while a health consumer waits to see a health practitioner, such as a physician, nurse, and/or physician assistant. A health practitioner is any natural person who provides one or more medical or health-related activities on a profit, nonprofit, professional or volunteer basis or who is acting under the direction of such person in the performance of such an activity. A health provider is an entity that provides medical or health-related activities, including health practitioners, hospitals, outpatient clinics, corporations, partnerships and other business entities involved in the healthcare industry. The present systems and methods may be used in outpatient or inpatient facilities, including waiting rooms, examining rooms, doctor's offices, telemedicine outreach facilities, hospices, private homes, or any other location where a health consumer receives or waits for a health practitioner's evaluation or where a health consumer provides health data. Health consumers include patients as well as family, friends or other persons accompanying or assisting patients before, during, or after health practitioner evaluation, including assisting with providing health data.

The present systems and methods can have numerous potential benefits and features, including but not limited to:
Leveraging time in waiting room for data entry and point of care marketing
Providing an alternative marketing channel for life science companies (LSCs);
Providing government entities with the ability to efficiently coordinate drug recalls or adequately inform health providers and health consumers about health product or service warnings;
Providing government entities with the ability to provide marketing presentations, including academic detailing that would target health providers and health consumers about generic health products and health services that have the same or comparable efficacy as their brand name counterparts but are less expensive than their trade name counterparts;
Providing marketing presentations about a health product or health service at a point-of-healthcare-access, such as an outpatient or inpatient facility;
Empowering physicians to review direct-to-consumer marketing presentations;
Preventing health consumers from reentering health data on subsequent visits;
Providing a marketing presentation to a physician (health practitioner) and to his or her patient (health consumer) that is identical in form and content and thereby eliminating a problem associated with current DTC advertising, where the health practitioner is not familiar with the DTC commercial viewed by the health consumer;
Creating a network of health providers for group purchasing of transcription, billing, scheduling, and other health products and services;
Reducing redundant questions to health consumers;
Improving health consumer healthcare data fidelity;
Reducing medical errors;
Providing health consumers with useful marketing presentations;
Providing health consumers with the ability to correctly identify their medications or conditions using pictures;
Enabling communication with Non-English speakers;
Creating a mechanism to generate active market leads;
Ordering medications from clinic with virtual pharmacy;
Decreasing number of called-back prescriptions because of illegible handwriting;
Creating a portal between life science companies and health providers to exchange ideas, order drug samples, view product launch campaigns;
Providing network for an effective and affordable electronic medical record (EMR) system that can connect a plurality of outpatient and/or inpatient facilities regardless of location, OS platform, or network architecture; and/or
Collecting valuable metrics that will allow for near real-time data measuring the effect of promotion campaign (marketing presentations) with respect to prescriptions written, prescriptions, both new and refills.

Health data can be obtained from a health consumer in any suitable way, but will usually be obtained by conducting an interview designed to elicit relevant health data, such as by asking a series of questions. Preferably the health data is obtained by asking questions approved, customized or designed by a health provider, or by providing one or more pictures to a health consumer so the health consumer can identify a medication, device, or a health condition by image. The interview obtains health data from the health consumer, including but not limited to gender, age, tobacco use, past medical history, symptoms, medication and device use, and health consumer diagnosis. Some or all of the health data can then be used as targeting criteria to appropriately target the marketing presentation.

The health data can be obtained through the use of a health consumer interface. Preferably the health data is obtained through an electronic interview, which may be conducted via an electronic health consumer interface. The interview and other aspects of the health consumer interface may be provided via a computer, such as those described below. The health data is obtained from the health consumer at or near the geographical or chronological point-of-healthcare-access prior to being evaluated by the health provider. The electronic interview and/or the obtained health data can be assigned an identifier (that is, a tracking code), and the interview and obtained health data can later be accessed using an identifier. The identifier can be a randomly assigned symbol, image, or number that serves as an anonymous identifier (a form of a non-identifying tracking code) for the health consumer. The identifier can be used before, during, or after the interview or visit to the health provider. The electronic interview conducted in the language identified by the health consumer (English, Spanish, or another language) upon accessing the system or method.

A health consumer interview comprises a series of questions, and each question is shown with a set of offered responses although a write-in response may be permitted. The responses to interview questions will appear in the designated categories on a printed health consumer interview summary report (the tangible paper report). From the interview designer's perspective, a “question” can comprise: (1) Prompt text—what the health consumer sees on-screen; (2) Report text—the text label that appears in the printed report; (3) A set or range of allowed or offered responses; and (4) Report category designation which indicates where the response should appear in the printed report. The responses to certain questions may be of greater importance to other functions of the present systems and methods. For example, some questions may have roles in directing the flow of questioning and others may determine which marketing presentation will be presented. The interview questions may be standard in the health provider's specialty or may be newly developed. The present methods and systems provide for customized interviews, where a health provider is able to customize the questions and/or possible responses.

The health consumer interface can begin with the introductory screen of the health consumer interview. The health consumer interface need not take the exact form shown in the Figures herein, but a suitable health consumer interface design can follow guidelines such as: (1) Input controls should be made large in order to simplify pen or touch input by the health consumers. For the same reason, there should be ample space between controls to reduce input mistakes. (2) The health consumer interface should have high readability. The interface design should incorporate significant color contrast, clear and readable type, a large-type option, and consideration of color-blind users. (3) The interface design should provide visual feedback. Health consumer input should be acknowledged with appropriate visual or audio effects.

Upon completion of an electronic interview, an electronic form can be generated that includes the health data provided during the electronic interview by the health consumer, who then may review, edit, confirm, or reject the health data. Once confirmed by the health consumer, the validated and populated electronic form can forwarded to a printer and/or an electronic data storage device such as but not limited to a USB drive, compact flash card, secure digital card, and/or medical record central server.

A paper form can be generated by the present systems and methods. When the health consumer finishes answering all the questions, a paper form can be automatically generated with the pertinent health data. The configuration of the form can be preformatted by the physician to meet the customized needs of her practice style. The paper form can be formatted so that questions that were not answered by the health consumer are excluded. This form can print out at the nursing station. Subsequently it can be used by the physician during his or her encounter with the health consumer in the exam room.

Additionally, health consumer interview responses may be saved to an individual removable storage card (e.g. a CompactFlash card). The card can be physically stored with the paper chart or given to the health consumer. The data on the card will not have any information regarding health consumer's name or identification number. The responses can be stored as XML files containing the date of the interview and the following data for each interview question:

| | |
|---|---|
| Question ID # | Response ID # |

On the next interview, the stored responses are retrieved and can be presented to the health consumer in summary format. The health consumer can then update his/her responses and respond to any questions that have been added by the doctor since the last interview. Using the interview date, it can also be determined if the health provider has made changes to the form since the last interview date and changed questions can be presented to the health consumer as appropriate.

Health data is obtained from a health consumer, and one or more marketing presentations are selected based on one or both of health provider health provider data (including but not limited to health provider specialty and/or health provider geographic area), and obtained health data (including but not limited to health consumer gender, health consumer age, health consumer symptoms, health consumer medications, health consumer diagnosis, health consumer history, and/or health consumer tobacco use). The obtained health data is dynamic data, in that it can change for a health consumer between visits to the health provider, and will likely be different for different health consumers. The health provider data will generally be static data, in that the data will not change for an individual health provider (or at least not change significantly or frequently), and the data may not differ significantly between different health providers.

The present methods and systems can include printing or means for printing a paper form as a record containing at least some health data obtained from the health consumer. The present systems and methods can include excluding or means for excluding from the paper record one or more questions to which the health consumer had no response. The present methods and systems can include formatting, or means for formatting, the electronic form and/or paper record to reflect pertinent positive and negative health data. Pertinence can be predetermined by the health provider, the system administrator, or on another accepted medical basis. The paper record may be printed using a printer which is adapted for communication with a health consumer interface, such as a computer terminal or a handheld tablet, or with an intermediary to the health consumer interface, such as a server configured for communication with the health consumer interface and the printer. A networked printer can generate a hard copy of the validated electronic form, which enhances the health evaluation process by improving health data fidelity, because it is provided directly from the health consumer as opposed to a health assistant or technician. This also saves the health provider time and resources by standardizing the location of pertinent health data, by leveraging the health consumer's own time to enter relevant health data which the health provider requires for a thorough evaluation, by actually documenting the pertinent health data such that it does not have to be re-documented by the health provider during the evaluation process, and by avoiding the redundant questioning the health consumer experiences during a health provider evaluation.

In addition to generating the paper record, the present methods and systems may including storing or means for storing obtained health data for subsequent visits to the health provider. A portable or fixed electronic data storage device stores a soft copy of the validated electronic form to be used for subsequent health evaluations such that pertinent health data does not have to be reentered manually into the electronic interface by the health consumer.

The present systems and methods can also include a means or module configured for a health provider to approve one or more aspects of the health consumer interface. The present systems and methods can also include a means or module configured for a health provider to adjust one or more aspects of the health consumer interface. For example, a health provider interface can enable a health provider to review and approve, reject and/or adjust marketing presentations to be provided to health consumers under the care of that health provider. Additionally or alternatively, the health provider interface can enable the health provider to review, add, delete, and/or adjust questions asked of the health consumer. Preferably, the electronic interview and/or other aspects of the health consumer interface can be adjusted by the health provider. A health provider interface preferably comprises an interview builder interface configured to enable a health provider to add, remove, or adjust interview questions in the health consumer interface. The health provider interface is designed to guide the health provider through a process enabling health providers to create customized electronic interviews in order to best preserve the style, type, and order of questions the health provider is accustomed to asking during the health consumer evaluation process. Optionally the interview builder interface can enable health providers to communicate with health consumers in numerous different languages using a language table which correlates words and phrases from different languages with one another or can provide one or more pictures to a health consumer whereby the health consumer can identify a medication or a health condition by picture.

Optionally, the health provider interface can access a database containing a collection of electronic interviews prepared and/or approved by various health providers. The electronic interviews can be stored and can be accessed (free of charge or on a fee basis) by health providers to use as a template for his or her practice.

The health provider interface can also include a health provider approval interface configured to enable a health provider to approve, reject and/or adjust a marketing presentation before the marketing presentation is available to a health consumer under the care of that health provider. The present methods and systems can include a health provider approval module configured to give a health provider approval over the marketing presentation before the marketing presentation is available to the health consumer.

The health provider interface enables a health provider to review the marketing presentation to be provided to the health consumer. In this way, the health provider retains control over the information provided to his or her health consumers in the provider's facility. The health provider interface can include a veto button. The health provider interface can include a means for adjusting the marketing presentation instead of or in addition to the means of accepting or rejecting the marketing presentation. For example, the health provider interface may permit the health practitioner to selectively delete or otherwise edit portions of the marketing presentation. The health provider interface can also permit the health provider to adjust the interface posed to the health consumer for obtaining health data and/or the paper form containing the obtained health data generated by the systems or methods. The present methods and systems can include means or modules configured for performing one or more of those functions.

The health provider interface can also permit (1) remote access by the health provider, (2) communication (such as email or instant messaging) between the health provider and life science companies, including requests, offers and delivery management of marketing materials, samples, or other items. The present methods and systems can include means for performing one or more of those functions.

An interview builder interface may be part or a subsection of a health provider interface or may be a separate element. This interface is intended to permit a health provider to easily customize interviews.

The present systems and methods can also include a presentation approval interface or module that enables a health provider to review the marketing presentation that may be presented to health consumer. For example, through a web browser, a health provider can enter a password-protected control panel. The control panel includes a marketing materials approval page. This page queries the database and displays a table of available marketing materials. Each item in the table includes a hyperlink to view the content; a pushbutton labeled “Approved”; and a pushbutton labeled “Not Approved”. When the doctor chooses “Approved” or “Not Approved,” the appropriate database entry is updated accordingly.

A marketing presentation can be selected for a health consumer based on the health data and optionally health provider data. Generally the marketing presentation is in an electronic format. Selection includes selecting which marketing presentation(s) is provided to the health consumer and/or selecting the order in which marketing presentations are provided to the health consumer. Suitable formats for marketing presentations include Flash animations, digital video, slide shows, holograms, video projections, and others.

In general, the marketing presentation will be about a medical or otherwise health-related subject. Preferably the marketing presentation is about a health product or health service. Health products include prescription drugs, over-the-counter drugs, and medical devices such as pain pumps, cardiac defibrillators, and pacemakers. Health services include but are not limited to surgery, physical therapy, pharmaceutical therapy, psychotherapy, diagnostic services, and imaging services (for example, MRI, ultrasound, CT). Health services also include the performance of a medical, surgical, or psychological examination or procedure on a health consumer. Health products and services also include organ transplants, joint replacements, and collagen injections, for example.

The marketing presentation can be in the form of an electronic presentation, such as a video and/or audio commercial, infomercial, website, slide show, Flash animation, digital video, QuickTime video, Real Player Streaming Video, Microsoft video file or other type of presentation. For example, the marketing presentation may be an advertisement about a health product, or an infomercial about a medical device. The marketing presentation can include information about disease therapies, and risks of interventions or treatments. In addition to marketing, information about disease etiology, disease critical manifestations, and other useful information can be provided in the course of or apart from the marketing presentation. The marketing presentation can be animated or live action. The marketing presentation can be stored on a computer, a local server, or a central server. The marketing presentation can be Flash or another digital video format. Preferably the marketing presentation is in a rich media format such as Flash or a video format. The marketing presentation can be provided using any appropriate and effective combination of a variety of media elements, such as, for example, video elements; audio elements; movie elements, still picture, photographic or other graphic elements; text elements; interactive hyperlink elements; and advertising elements.

The marketing presentation can be selected based on the health data obtained from the health consumer and/or data about the health provider. The marketing presentation can be selected based on one or more of (a) geography, i.e., location of the health consumer and/or health provider; (b) specialty or subspecialty of the health provider; (c) one or more health products previously taken by the health consumer; (d) one or more symptoms of the health consumer; (e) one or more diagnoses of the health consumer; (f) health consumer age; (g) health consumer gender; (h) health consumer tobacco use; or (i) other targeting criteria. The marketing presentation is presented or made available to the health consumer based on these or one or more other targeting criteria. After the health consumer inputs his or her health data, one or more marketing presentations can be selected. The selected marketing presentation can be automatically presented to the health consumer, or the health consumer may be asked whether he or she wishes to see a presentation.

The marketing presentation can be implemented as a computer program which is accessed by a processor in the computer used by a health consumer (such as an electronic tablet or another health consumer interface). Preferably the health consumer interface accesses the marketing presentation from a storage means by wireless communication. Storage means for the marketing presentation include but are not limited to a local server and can be located in a computer used by the health consumer, a local server or a central server. Preferably the marketing presentation is stored on a local server or other storage medium such as a CD-ROM, USB drive, Compact Flash, or a Secure Digital Card. The marketing presentation can be accessed using either a CD-ROM/DVD drive or a network port; communicated visually by the touchscreen and audibly by the speaker or the headphone jack; and navigated or otherwise controlled through the touchscreen, mouse, or keyboard.

The marketing presentation can be presented to the health consumer without further action by the health consumer immediately after the health consumer completes the input of health data, or after the transfer of health data to an electronic storage device or to a paper form. Alternatively, the marketing presentation can be made available to the health consumer at the health consumer's initiation. For example, after the transfer of pertinent health data to printer and/or electronic storage device, the present methods and systems may provide the health consumer with a menu on the health consumer interface displaying multiple links to the authenticated marketing presentations, such as approved targeted direct-to-health-consumer promotions. The options of links available to the health consumer can be determined by a content provider and/or a health provider using a content provider interface or a health provider interface (respectively). Such interfaces enable content providers, health providers or other healthcare entities to remotely place and target marketing presentations to be viewed by health consumers.

The health consumer interface enables health consumers to initiate a marketing presentation. Preferably, the health consumer interface can enable health consumers to choose a marketing presentation through digital identification such as click or touch.

Once launched, the initiated marketing presentation is presented to and viewed by the health consumer. Preferably, the health provider has previously approved the presentation. In this manner, the present systems and methods provide direct-to-health-consumer marketing presentations which have been approved by health provider. That is, the present systems and methods can provide targeted authenticated content to health consumers based on a cooperative relationship between content providers and health providers. The methods and systems can include recording the health consumer's viewing of the presentation as a viewed presentation. For example, a recording module can include an identifier of each marketing presentation viewed by a health consumer. Optionally, upon completion of the initiated marketing presentation, the present systems and methods provide the health consumer with an option to request more information on the health product or health service, either immediately via the patient interface or subsequently by mail, phone, email or other modes of communication.

The present methods and systems can include offering, or a module configured for offering, the health consumer options with respect to use of health data and/or receipt of additional information about the health product or health service. For example, the health consumer may be offered the option of providing privacy-protecting contact information (address without name) which is stored on a secure database to be used in the event, for example, of an emergent outreach program by public or private sector entities to inform health consumers of a recall. As another example, the present systems and methods may provide the health consumer with an option to authorize use of his or her name, address, phone number, or email address, or other contact information for marketing or other uses.

The present methods and systems provide life science companies with the ability to market health products and services in outpatient facilities (such as clinics) and inpatient facilities (such as hospitals), while simultaneously providing health providers with the ability to control the marketing presentations provided to health consumers under their care. Meanwhile, life science companies and other content providers have an opportunity to provide a target audience (health consumers having certain health data, such as particular health conditions or product needs) with in-depth life science flash animation infomercials and other targeted authenticated content that are extremely rich with pertinent health information. These marketing presentations can be viewed while waiting to be evaluated by health practitioner.

Content providers can include life science companies (such as pharmaceutical companies, biotech companies, and medical device companies), private payors of health products and/or services (such as insurance companies), public payors of health products and/or services (such as Medicare or Medicaid, or their counterparts outside the United States), government entities, other health providers, public interest groups, pharmacies, wholesalers and retailers of health products and/or services and anyone else with an interest in a health product or a health service.

The present systems and methods can provide for health product marketing using a variety of apparatus. For example, a content storage means such as a central server can be configured to store one or more marketing presentations regarding health products and/or health services, and one or more local servers can be configured to communicate with the central server and to receive the marketing presentations. A health consumer interface can be configured to communicate with the local server. A health provider interface can permits adjustment of the health consumer interface. A content provider interface can permit a content provider to add, remove, or adjust the presentations for the health consumer interface. Preferably it does not permit the content provider to view individually identifiable health information. The health consumer interface is adapted to obtain health data, and the local server is configured to receive health data from the health consumer interface and to select one or more presentations based on the health data. The health consumer interface is adapted to present the selected presentations in an electronic format.

The present systems and methods can be used for collecting information regarding prescriptions without disclosing information that identifies the health consumer. A tracking code (preferably a non-identifying tracking code) is assigned to a health consumer. The health consumer is shown one or more presentations for a health product. The presentations shown to the health consumer are associated with the tracking code. A determination is made whether the health consumer purchased a health product, such as by determining whether the health consumer purchased a medication via a drug shopping price-bot. In this way, purchase information is obtained, and this purchase information can also be associated with the tracking code.

The present systems and methods can include means for purchasing prescription medications. If the health practitioner prescribes medication, the health consumer has the ability to request the prescriptions from a vendor at the point-of-healthcare-access using an electronic interface. Preferably, the electronic interface uses the same tracking code (which is preferably a non-identifying tracking code, such as a randomly assigned image, symbol, or number) used in connection with the electronic interview when initiating the prescription purchasing interface. The prescription purchasing interface enables the health consumer to enter prescribed medication and dose to view comparative data, including but not limited to price amongst various pharmaceutical suppliers (local and online). This interface enables health consumers at the point-of-healthcare-access to provide the documentation to initiate the prescription request which can minimize errors due to poor handwriting recognition. The health consumer ultimately decides on a pharmaceutical provider and the transaction is fulfilled, recorded, and registered.

The tracking code (such as the randomly assigned image, symbol, or number code) can be used as a link between the marketing presentation(s) shown to the health consumer and whether the health consumer received a prescription (prescription information) and/or whether the health consumer purchased a health product or health service through the electronic interface (purchase information). The tracking code can have other things associated with it, including but not limited to health data such as symptoms, diagnoses, or previous medications. The tracking code provides a way to link data from the electronic interview and the prescription information and/or purchasing information, and thereby provide a mechanism to evaluate marketing efficiency in near real-time.

The present systems and methods may be provided in the form of one or more modules. For example, modules can be included which are configured to interview a health consumer for health data, select marketing presentation based on the obtained health data, and/or provide the marketing presentation to the health consumer in electronic format. Some or all of the modules can be embodied as software modules that are executed by computer hardware of the system. As will be understood by one skilled in the art, such modules can but need not be embodied as separate sections of computer code. The functionality of various modules can be embodied together in one or more code sections. Some modules can be embodied partly or wholly through human participation, such as by setting up a team of employees to perform a certain function. In some instances, modules can be embodied using human participation in addition to, in conjunction with, or instead of computer code executing on hardware. The human participation may involve, for example, human analysis or interpretation of data, human use of the computer code, or human interaction with physicians that use the system.

The present systems and methods (especially those comprising software, such as one or more computer programs) may be provided in the form of one or more code segments. Code segments can be included which are adapted to interview a health consumer for health data, select marketing presentation based on the health data, and/or provide the marketing presentation to the health consumer in electronic format. The software can include code segments to perform the other functions described herein. For example, the software can include a code segment adapted to electronically import health data from a source other than the interview.

The present systems and methods can be configured to be compatible with other software systems and methods. For example, the present systems and methods can be configured to be compatible with commercially available software for Electronic Medical Records (EMR) systems. As another example, the present systems and methods can be configured to be compatible with software operated by content providers and/or vendors of health products and health services.

The present system and method can be enabled through various hardware implementations as will be understood by one skilled in the art. Various apparatus can be used to implement the foregoing systems and methods. Descriptions of some useful apparatus are provided herein as non-limiting examples. A computer of some type will usually be made available to the health consumer. The computer is provided for obtaining the health data from the health consumer in an efficient manner. The computer can be used to provide a health consumer interface. The computer can be a handheld, a laptop, a desktop, a computer on wheels (COW), or another type of computer. The computer can be fixed in place or portable. Preferably, the computer is a portable low-tech, touch-screen, multimedia enabled electronic tablet that can be handed to the health consumer while he or she awaits the health practitioner. However, virtually any type of computer capable of running the computer software as described herein may be used. For example, a stationary computer terminal, handheld or fixed electronic tablet or other computer may be used. The computer is configured so that a patient can enter health data for charting purposes. Suitable tablet computers (hardware) are currently available from vendors of computers. The computer will preferably have a touch-screen interface. The computer used by the health consumer may be linked to one or more other computers and is preferably linked to a central server and/or a local server (e.g., individual office server) operatively connected to one or more tablets.

The hardware apparatus for the present methods and systems can include other components, such as a housing; a processor; CD-ROM/DVD player or a network port; a keyboard; a speaker and/or a headphone jack; a volume control knob; and a power plug.

A processor in the electronic tablet (or other computer, or in a local server in operative communication with a health consumer interface) is adapted to access, control and communicate the marketing presentation, and to receive health data from the health consumer. The computer may include or be operatively connected with a CD-ROM/DVD player adapted to receive a memory device or medium on which the marketing presentations are stored. The computer or player is adapted to retrieve the marketing presentation and to provide the retrieved marketing presentation to the processor. Alternatively or additionally, the system may include a network port adapted to allow for connecting the processor to a local or wide area network so that the presentation can be accessed from a remote host.

As mentioned above, the computer is preferably an electronic tablet, more preferably a tablet having a touchscreen. Such electronic tablets are already commercially available. The touchscreen may be adapted to both visually communicate a visual component of the presentation and to allow the health consumer to navigate or otherwise control the presentation. Movement of an object, such as a finger, stylus, or other pointing device, on the touch-sensitive surface of the touchscreen results in an input being provided to the processor for navigation or control. In this manner, the health consumer can touch a virtual control that is part of the marketing presentation to provide control input. Thus, the touchscreen provides a mechanism for controlling the marketing presentation. The hardware apparatus may also include a keyboard for providing input to the computer.

A printer can be provided for printing a tangible record or form of the health consumer's health data after the health consumer has inputted his or her health data. By printing a paper record, the risk of loss due to an electronic failure is minimized. As desired, the printer can provide other verification and documentation (e.g., a usage report with date/time stamp) of the health consumer's having used the system and thereby received the presentation.

Software Architecture

The software program architecture can be considered as having a front end and a back end. The back end has a set of PHP script files that process information and communicate with a MySQL database. Specifically, the back end has Linux, Apache 2.0, MySQL Server 4.1, and PHP 5.0. The PHP scripts use built-in PHP database access functions to interact with MySQL. Considerations include reliability, performance, scalability, maintainability, and ease of deployment. The front end is designed in HTML using Cascading Style Sheets and JavaScript to enhance presentation. The program is thus accessed from Tablet PC client machines through a conventional web browser such as Internet Explorer or Netscape.

Data Management

Within the health provider's office, information can be managed in different places, for example, a MySQL database, a server file system, or a removable storage card specific to each health consumer. Preferably, the local server file system will serve as storage for marketing presentation due to the size of such files and the fact that there is no utility in storing them in the database itself.

Using a content provider interface, the system can be accessed through a web application hosted on a central server. A content provider, such as a life science company, logs on to the application with a unique username and password. Upon logging in, the content provider can perform functions, such as: (1) Viewing reports of the performance of their existing campaigns (marketing presentations); (2) Adding a new campaign; and/or (3) Adding or changing selection criteria or which marketing presentation is selected based on health data. This is a means through which a life science company can upload their marketing presentations (content) and indicate how to target the content. This page allows a life science company to provide by uploading new promotional campaigns in Flash or permitted digital video formats. The life science company provides target criteria for selecting each marketing presentation: Target specialty (selected from a list of specialties and subspecialties); Target location; Target age range (a single interval of whole numbers, e.g. 40 to 55); Target gender; Target medication class; and optional items such as content expiration date. The content provider interface can also include access to tracking codes and associated information, such as viewed presentations, prescription information, purchase information, and other data. The content provider interface can be designated so that access by a content provider to personal information of health consumers is prevented.

Adding a new campaign (marketing presentations(s))

The present methods and systems also include means for a life science company or other content provider to add additional marketing presentations, such as updated drug information or a new campaign for a medicine. For adding a new campaign, the present methods and systems include an interface for the life science company (or other content provider) to enter the following information for the new campaign: (1) Internal campaign name (for life science company reference only; not presented to health consumers); (2) Public title for the campaign which is the message that will be displayed to health consumers inviting them to view the information (e.g. “Learn how Mr. Somebody quit smoking for good.”); (3) The medical specialties and subspecialties at which the campaign will be targeted; and/or (4) The medication classes at which the campaign will be targeted, which may be limited (e.g., up to a limit of 5).

The present methods and systems can allow a life science company or other content provider to specify a campaign's target demographics. In this step, the life science company or other content provider can select: (1) One or more (possibly all) target age ranges. For example, the age ranges may be 18-25, 26-35, 36-45, 46-55, 56-65, 66-75, or 75+; (2) One or more (possibly all) of the fifty U.S. states; (3) Zero or more (possibly all) of the top 25 major metropolitan areas in the United States or another geographical area; and/or (4) other targeting criteria.

The present methods and systems can include allowing, or means for allowing, the life science company, government entity, or other content provider to bid for competitive positioning of its marketing presentation(s) with respect to a selected medication class. This will be the interface to the system operator's campaign pricing mechanism. The variables in pricing are: (1) The amount that the life science company, government entity, or other content provider will pay per impression; (2) The number of times that the campaign will be presented in a day; (3) The content provider's chosen daily budget limit; (4) The number of physicians in the operator's network; and/or (5) The empirical impact variables generated with proven market data.

Promotion Content and Storage

The present systems and methods will generally use marketing materials that conform to a set of technical standards or requirements. For example, flash movies should be of specified screen dimensions (e.g. 480×240) to fit appropriately into the space available in the health consumer interface (available on an electronic tablet screen).

Each medical presentation will be stored with appropriate target identifiers, for example (1) Target specialty; (2) Target zip code; (3) Target gender; (4) Target age; and (5) Target drug class. These target identifiers will be used by the present systems and methods as selection criteria to coordinate the marketing presentations between life science companies, health providers, health consumers, and possibly others.

Promotion Publishing Mechanism

Through a web browser, a life science company or other content provider can access a content provider interface, such as by entering a password-protected pharmaceutical portal hosted on the corporate server. This page allows the life science company to upload new marketing presentations or other content in Flash or other permitted digital video formats. The upload script verifies that the uploaded file meets the technical requirements. It then saves the file on the corporate server file system and adds an entry to a database table. The database table will automatically broadcast the marketing presentation to the appropriate target based on the key target identifiers.

Promotion Distribution Mechanism

As mentioned above, local servers in or near a health provider's facility will store the marketing content. The local server may be one which is used by the health provider for other purposes or one which is dedicated to use of the present systems and methods. The local server is configured for communication with a source of content such as a central server. The local servers can download new and updated marketing presentations or other content from a central server.

The download operation can be executed by a scheduled task (cron job) that runs periodically or occasionally. Preferably, it will be run once daily. A mechanism will be implemented that will have the scheduled downloading times for the various local servers distributed throughout the hours of 10 PM-4 AM such that they do not overwhelm the central server by downloading at the same time. A health provider's specialty and subspecialty are recorded in the local servers, such as by a specialty and/or subspecialty code. This allows the local server to download only relevant content that pertains to the health provider's specialty.

Preferably, the marketing presentation(s) is previously stored on the tablet, rather than downloaded or streamed from the local server during viewing by the health consumer. An automated task will perform the task of pre-loading/caching of marketing materials on Tablet PCs on a nightly basis. This will eliminate the need for these large files to be downloaded from the server while a health consumer is using the system.

Real Time ROI Measurement

In another aspect, systems and methods are provided for evaluating the effects of a promotional campaign, which may comprise one or more marketing presentations. Software and modules for associating a marketing presentation with a physician's prescription decision (prescription information) and/or a purchase of a health product or service (purchase information), such as a prescription medication, can be included in the present methods and systems. Preferably, a non-identifying tracking code is employed to make such association without revealing identifying the health consumer.

The present systems and methods can include means to measure the impact of promotional campaigns (such as one or more marketing presentations), including means to measure the impact in real-time. The impact can be measured in real-time or near real-time by correlating the marketing presentation with the purchase information using the drug shopping price-bot and proving the correlation to the life science company in real-time (shortly after the purchase is made). By having a virtual pharmacy interface in the clinic, the health consumer will have the ability to request prescriptions online in the health provider's facility.

After seeing a physician and receiving a prescription for a medicine (or advice to take a non-prescription medication), the health consumer is provided with a tablet, a computer workstation, or another health consumer interface. This may be a part of the same health consumer interface employed to obtain the health data, or a different health consumer interface. The health consumer can use the same computer that was used to enter health data, or a different computer. Using the health consumer interface, the health consumer will enter the name and dose of the medicine prescribed or recommended by the physician. A list of pharmacies, the price, date of delivery, and possibly other options will be generated and displayed to the health consumer. The health consumer can then choose a pharmacy from which to purchase his or her medication(s).

The health consumer will have the option to fill the prescription at any of the pharmacies. This virtual pharmacy is designed to leverage competition among pharmacies in favor of the health consumer, thereby providing improved quality, enhanced health consumer satisfaction, and decreased price. More importantly, prescription-filling errors due to illegible handwriting would be eliminated. Even if the health consumer decides to go to their neighborhood pharmacy, the health consumer can save time and pick up the medication on the way home, as compared to placing the order at the pharmacy and waiting for the prescription to be filled.

In the tablet or local server, the prescription information and/or purchase information can be stripped of any identifying information (such as name, address, social security number or birth date) but is linked to the health consumer tracking code generated by the initial tablet (when the health data was obtained). The prescription is compared directly to the marketing presentation viewed. This one-to-one relationship is a tool to measure the efficacy of a promotional campaign.

The present systems and methods maintain records of associations between marketing presentation(s) and purchase of a presented health product or health service. Such records can be maintained in a MySQL database on the local server.

Non-identifying (privacy-protecting) tracking codes can be generated for health consumers. The tracking code can be associated with non-identifying health data, such as health conditions or medications. The tracking code can be associated with one or more marketing presentation. For example, a given tracking code can be associated with identifiers for each of the infomercials viewed by the health consumer associated with that tracking code. This database record can be later updated to indicate that the user actually purchased the product or service. The local server can be configured to store a database which contains database records of associations between tracking codes and presentations and optionally other information.

For information to be individually identifiable health information, it must identify the health consumer or there must be a reasonable basis for belief that the information could be used to identify the health consumer. Individually identifiable health information includes the health consumer's name, address, social security number, or birth date. Accordingly, a non-identifying tracking code does not include the health consumer's name, address, social security number, or birth date, and cannot be used to identify the health consumer.

In addition to the use of a non-identifying tracking code, the present systems and methods can include a health consumer authorization module in which a health consumer can authorize use of his or her individually identifiable health information for marketing or other uses.

This data is collected from medical offices during the system updates, which are preferably done on a nightly basis. An interface is provided in the operator administration portal for an operator to generate reports on presentation-purchase correlations.

Data Collection from Pharmacies

The present systems and methods can include a module or means for electronically shopping for a health product or health service. For example, the present systems and methods can also include a pharmacy shopping module or means. The present methods and systems can include an .XML or .RTF file schema of pharmacy inventory for drug information exchange. A drug shopping price-bot can be provided by the central server. A web portal allows pharmacies to log into their accounts and upload new pricing data files. This data is integrated into the pricing database. The present systems and methods specify the drugs and dosages that will be available through the virtual pharmacy interface and assigns each a unique identifier. A mechanism will be implemented to match drugs included in the pharmacies' .XML,.RTF, or other compatible file feeds with the drugs listed on the online pharmacy shopping mall.

A price-bot is a search engine for gathering prices of products from a variety of vendors. The present systems and methods can include a price-bot, or providing or using a price-bot, to shop for a health product or service, for example, for a prescription drug. Given a price request for a specific medication and dosage, the price-bot returns a set of search results ranked by price, from lowest to highest. The price-bot has the option to limit results to those within a given distance of a specified ZIP code.

The shopping interface allows a health consumer to search for the best prices for prescription drugs (or other health products or health services) in the area where he or she lives. A health consumer chooses the name of the drug (optimally, from a list) and enters his/her ZIP code. The shopping interface can be hosted at the central server or the local servers, and is accessible through participating medical offices.

The present systems and methods are further described by (but not limited to) the embodiments shown in the Figures and described as follows.

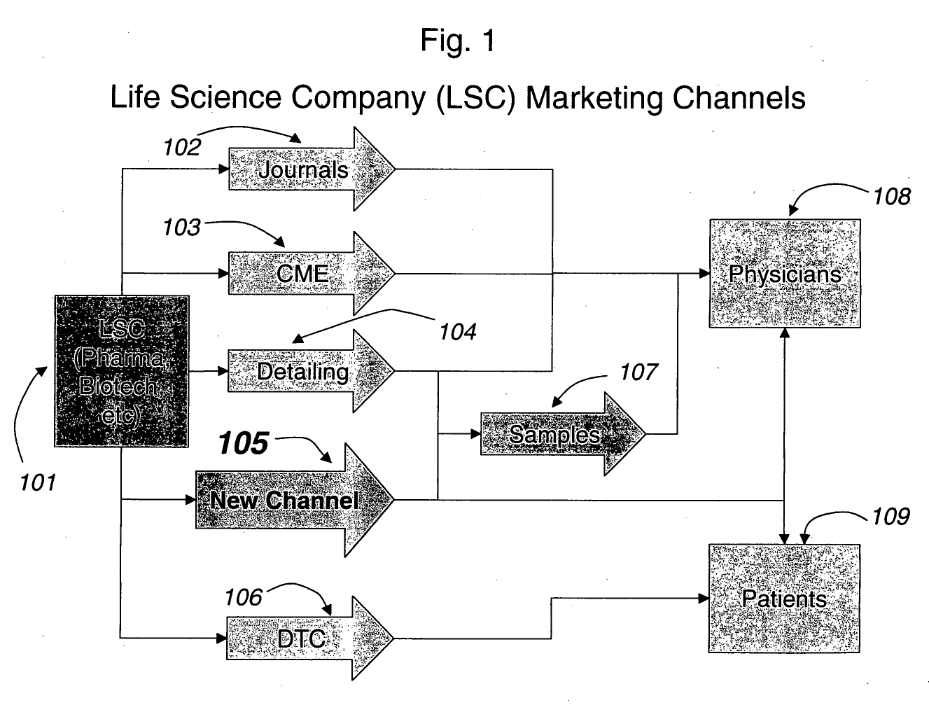

FIG. 1 shows various life science company marketing channels. Life science companies (LSC) 101 traditionally use various marketing channels such as journals 102, Continuing Medical Education (CME) 103 events, pharmaceutical representative detailing 104, and Direct to Consumer (DTC) advertising 106 to market products and services to physicians 108 and patients 109. The present systems and methods provide an additional marketing channel 105 that is efficient and effective. Life science companies or other content providers 101 often provide physicians 108 with drug samples 107 to give to patients 109 when indicated. The present systems and methods 105 are compatible with providing samples 107 to physicians 108 and patients 109.

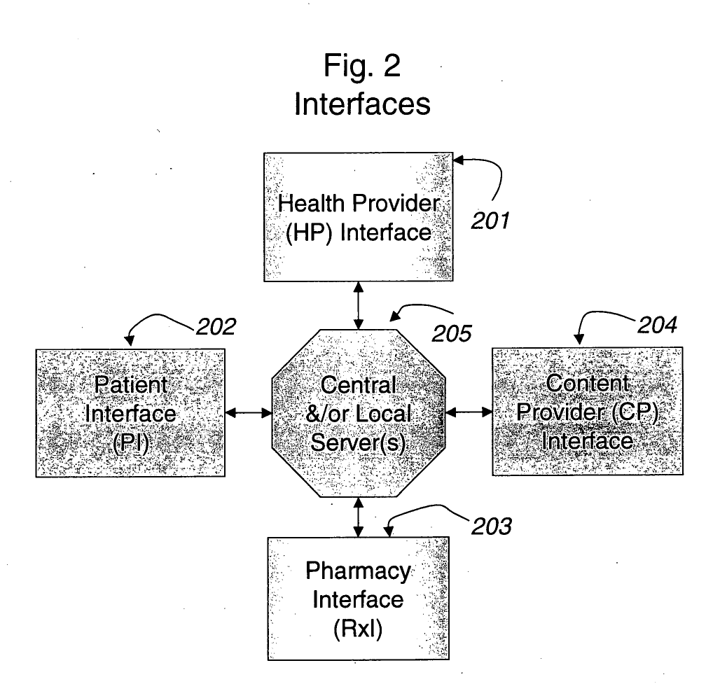

FIG. 2 shows the preferred interfaces that may be included in the present systems and methods. The central server(s) and/or local server(s) 205 directly or indirectly provides multiple interfaces including a Health Provider Interface (HCPI) 201, a Content Provider Interface (CPI) 204, a Pharmacy Interface (RxI) 203, and a health consumer interface (PI) 202.

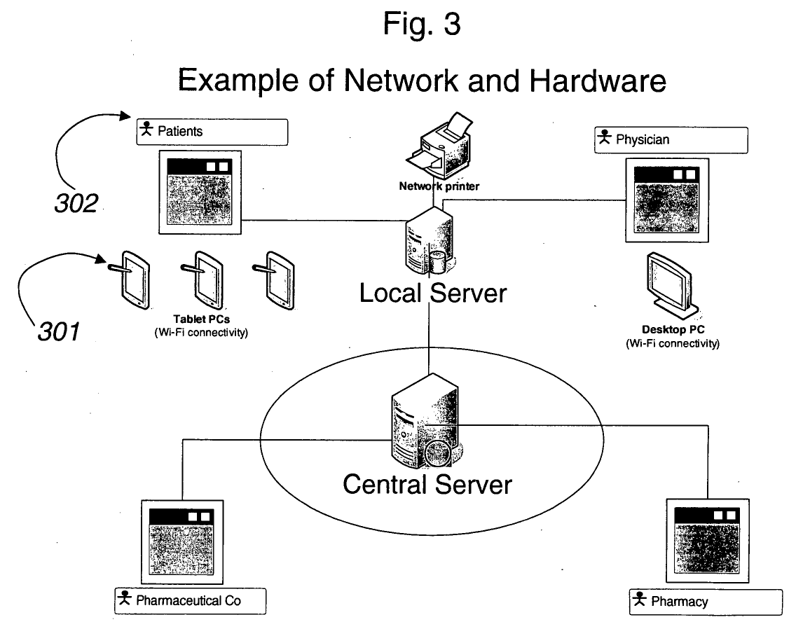

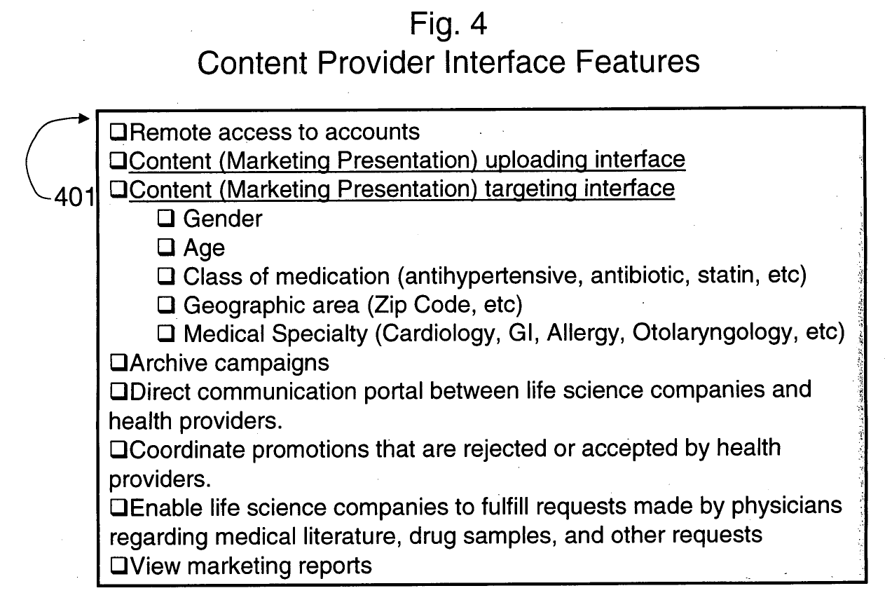

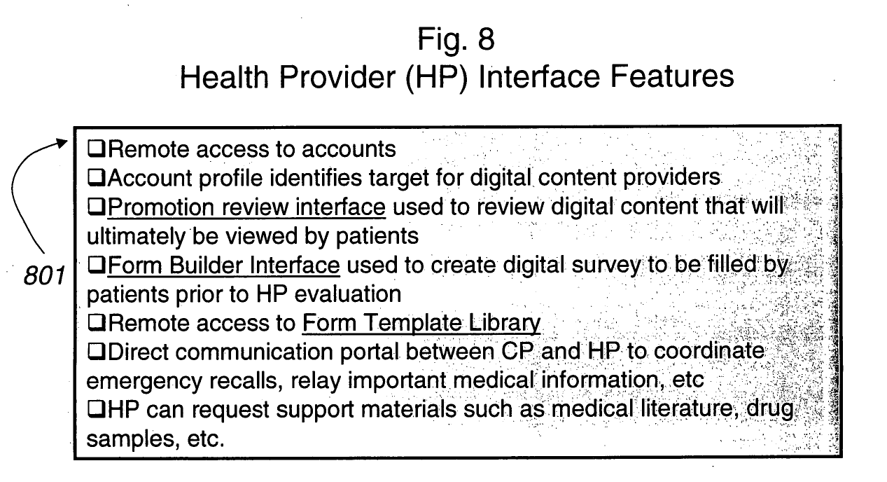

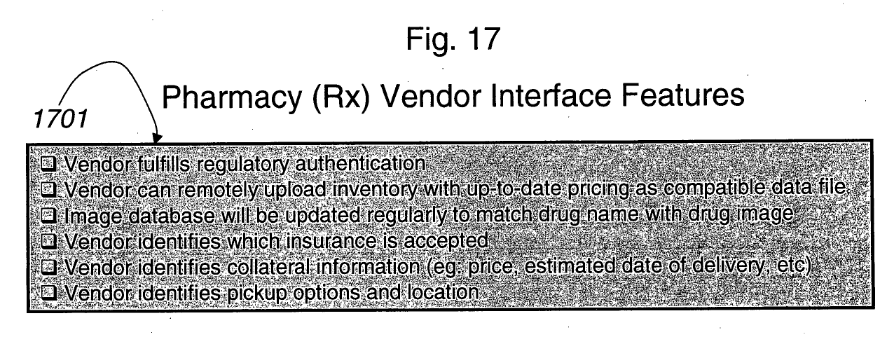

FIG. 3 shows an example of a network and how various hardware components relate to the network. The Tablet PCs 301 are an example of a handheld computer and can have a touchscreen interface that patients 302 use to enter health data. The tablet PCs 301 communicate with a local server wirelessly and send the health data to the local server and receive one or more marketing presentations from the local server. The local server directs a printer to print a summary form containing the health data. In addition to obtaining health data, the tablet PCs present marketing presentations to the health consumer. The local server can also provide a physician (health practitioner) interface having some or all of the features described above and in FIG. 8. The local server can communicate with a central server which provides a content provider interface for content providers such as pharmaceutical companies; the content provider interface can have some or all of the features described above and in FIG. 4. The central server can also provide a pharmacy interface for pharmacies (or other suppliers of health products or services) and having the features described above and in FIG. 17.

FIG. 4 shows desirable features 401 of the Content Provider Interface, although other embodiments of the content provider interface can include additional or fewer features. The present systems and methods provide content providers with remote access to accounts, a direct communication portal between life science company and health provider interface, and/or the ability to fulfill requests made by health providers, such as for medical literature or drug samples. The content provider interface can also provide content providers with marketing reports that reflect the effect of marketing campaigns, including but not limited to tracking codes and information associated with the tracking codes. The content provider interface can include a Digital Content (Promotion) uploading interface, and a Digital Content (Promotion) targeting interface that will allow the content provider to choose criteria such as gender, age, ethnicity, Class of medication (antihypertensive, etc), Geographic area (Zip Code, etc), Medical Specialty (Cardiology, GI, etc) to target marketing presentations to health consumers of their choosing.

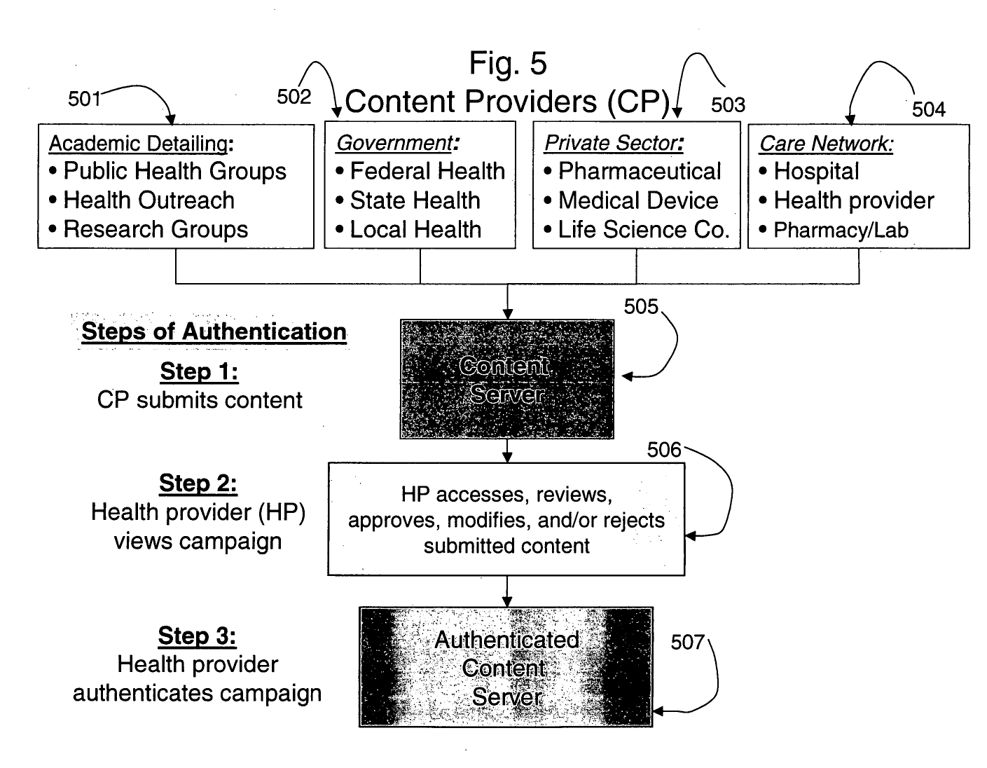

FIG. 5 shows some potential aspects of a Content Provider Interface. It is contemplated that content providers of many different types may have various interests in providing content for the present methods and systems. Content Providers can be any entity that wishes to provide content (one or more marketing presentations) including private sector entities 503, academic entities 501, government entities 502, and care network entities 504. Examples of government entities 502 include federal, state, and local governments. Examples of academic detailing entities 501 include public health groups, health outreach programs, and research institutions and foundations. Examples of private sector entities 503 include pharmaceutical companies, medical device companies, or other life science companies. Examples of care network entities 504 include entities which have direct or near direct contact with the patient such as a health provider, such as a hospital, pharmacy, lab, or imaging center. Content providers provide content in formats such as digital or electronic format. If the content providers provides content in the digital or electronic format, it is uploaded to a content server 505. Once the content is uploaded into the content server 505 it can be reviewed remotely by health provider 506 who can perform functions such as approving, critiquing, or rejecting submitted content. If the content is approved, the content is considered “authenticated” and managed by an authenticated content server 507. Optionally, a default for submitted content can be established for situations where the health provider does not act on the content within a certain amount of time. For example, some health providers may choose as a default that the submitted content is treated as authenticated if they do not take action within a certain amount of time. Other health providers may choose as a default that the submitted content is treated as not authenticated, and is not forwarded to the authenticated content server 507, if they do not take action within a certain amount of time.

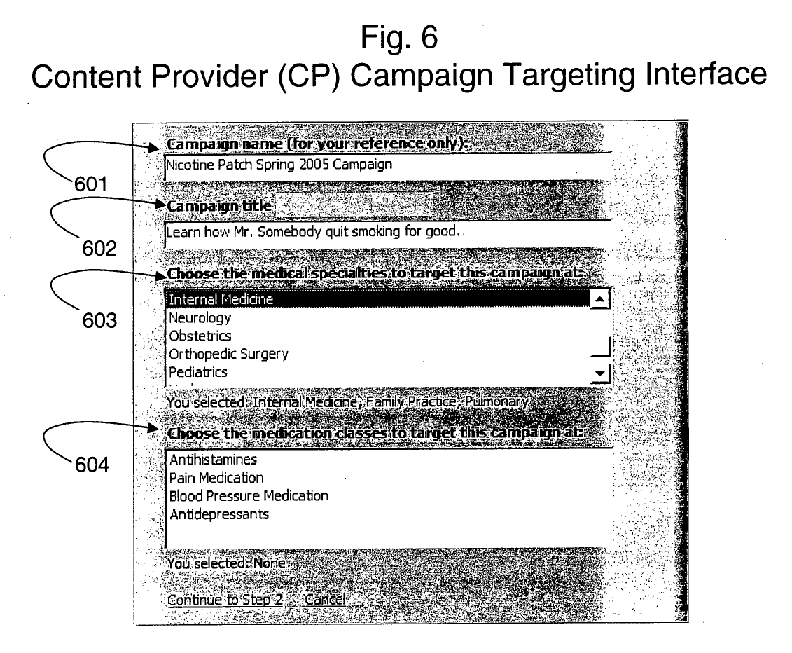

FIG. 6 shows a screenshot Content Provider Interface (CPI). This screenshot is taken from the part of the interface where the content provider targets marketing presentations for health consumers. In other words, in the content provider interface, the content provider enters selection criteria that will be used (by themselves or with additional criteria) to select marketing presentations, based on health data and/or health provider data. The content provider campaign targeting interface enables users of the present systems and methods such as government entities or life science companies to appropriately target their marketing presentations (campaigns) based on such criteria as pertinent medical specialty 603 or pertinent class of medication 604. The content provider will have the option to provide a campaign title 602 that can be displayed to the health consumer or health provider. The content provider will also have the option to create a campaign name 601 for campaign management purposes.

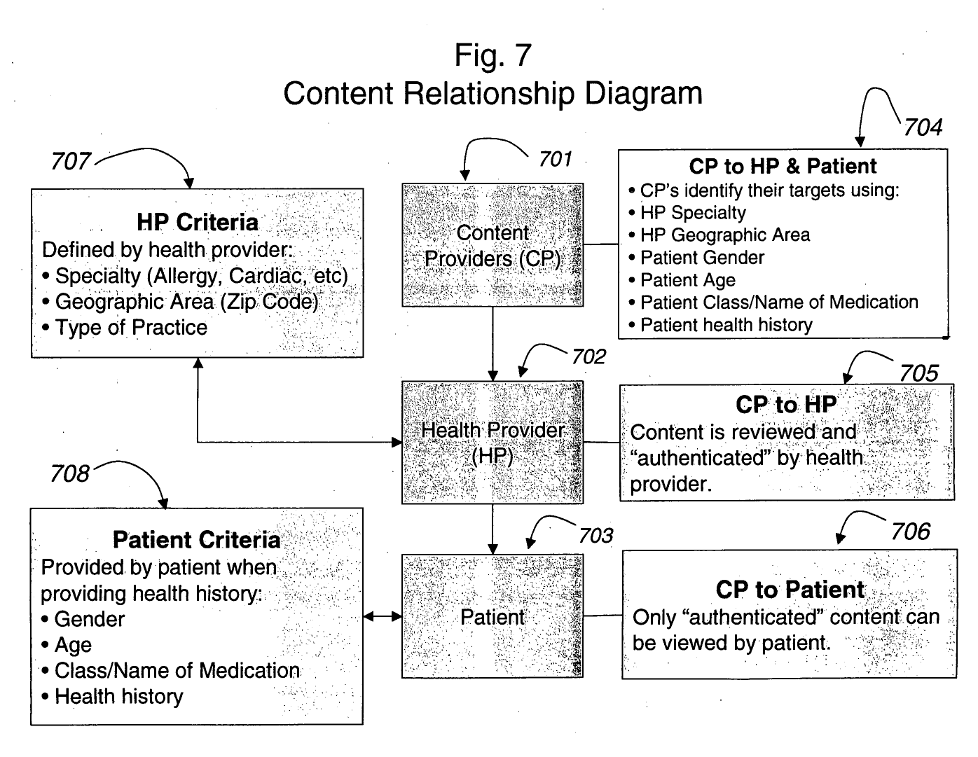

FIG. 7 is a diagram of a targeting digital content relationship. The targeting in the present systems and methods involves targeting the content provided by the content provider 701 to the appropriate health provider 702 and/or health consumer 703. The health provider 702, upon interaction with the present systems and methods, can enter health provider data, some of which can be selected as target criteria 707, such as specialty of practice, zip code(s), or type of practice. The patient, upon interactions with the present systems and methods, can enter health data, some of which can be selected as target criteria 708 such as gender, ethnicity, age, class or name of medications currently taking, or other pertinent health history. The content provider 701 identifies the appropriate campaign target 704 using such criteria as Health Provider specialty, Health Provider zip code, patient gender, patient ethnicity, patient age, class of medication patient is taking, name of medication patient is taking, and/or pertinent health history of patient. Only content authenticated by the health provider 705 can be available for patients to view 706.

FIG. 8 shows desirable features 801 of a health provider interface (HPI). With the present systems and methods, the health provider will have the ability to perform actions such as reviewing marketing presentations supplied by content providers, creating forms to be populated by patients prior to their evaluation, accessing a form template library to upload or download forms, communicating with life science companies or other content providers using a portal to help coordinate emergency recalls or relay important health information, or requesting support materials such as medical literature or drug samples.

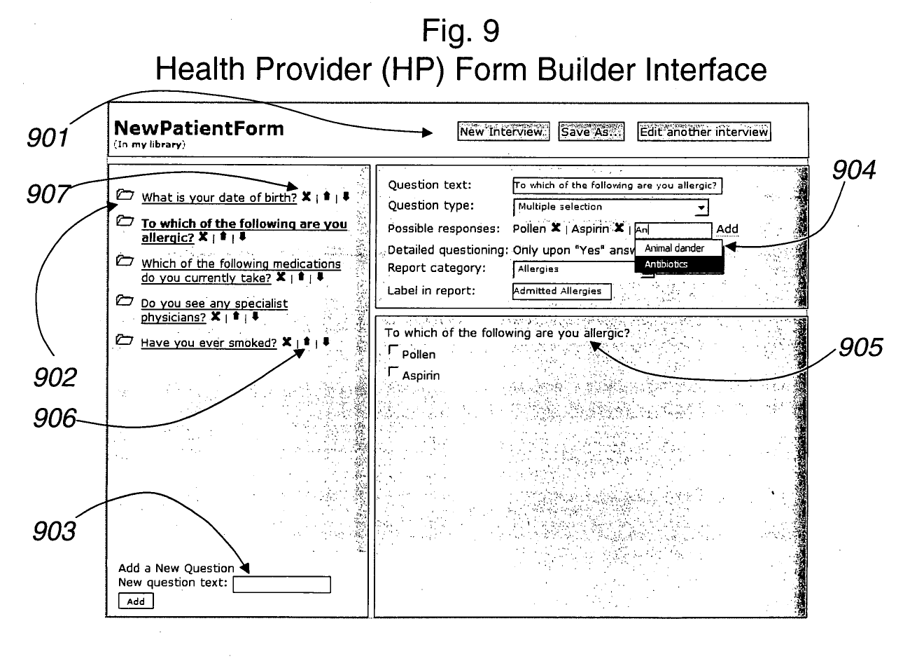

FIG. 9 illustrates a Health Provider (HP) Form Builder Interface. The health provider will be able to use the interface to create or modify patient forms 901 that will be used to collect data from the patient. The interface enables health providers to add, modify, or remove questions 903. The questions can be modified using features 904 defined by the health provider. A preview of the question 903 can be viewed in the preview window 905. The question order as viewed in 902 can be changed by the health provider using such features as the up and down arrows 906 or can simply be deleted by the “X” 907.

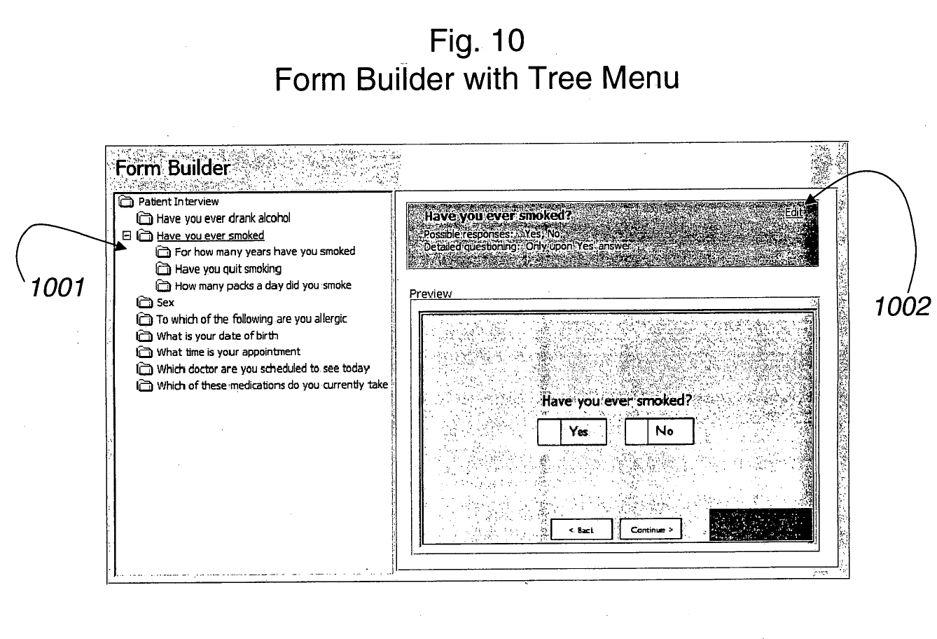

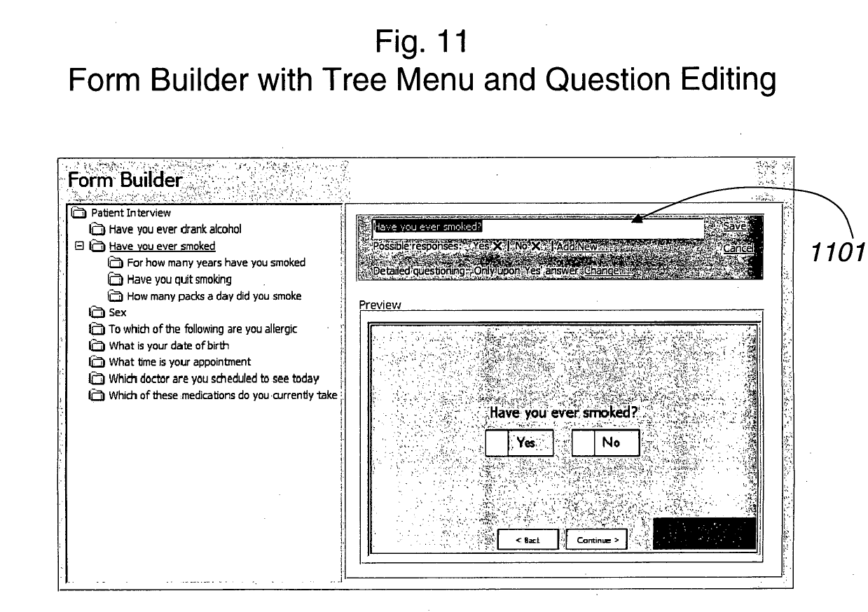

FIG. 10 shows an example screenshot of the form builder using a tree menu 1001 to help organize pertinent information such as questions. A question can be modified using, for example, an edit 1002 feature incorporated into the interface. FIG. 11 shows an example screenshot illustrating an example of how questions can be edited 1101. In the embodiments shown in FIGS. 10 and 11, the interfaces have two vertical panes, though a greater or lesser number of panes could be provided. The left pane features a tree view control that provides a structured view of the interview questions and their dependencies. The right pane includes a preview panel and may include an editing panel. The editing panel shown in FIG. 11 allows the question to be edited, and its functions include: adding and deleting possible responses, setting the question test, and setting the conditions for continuing into more detailed questioning.

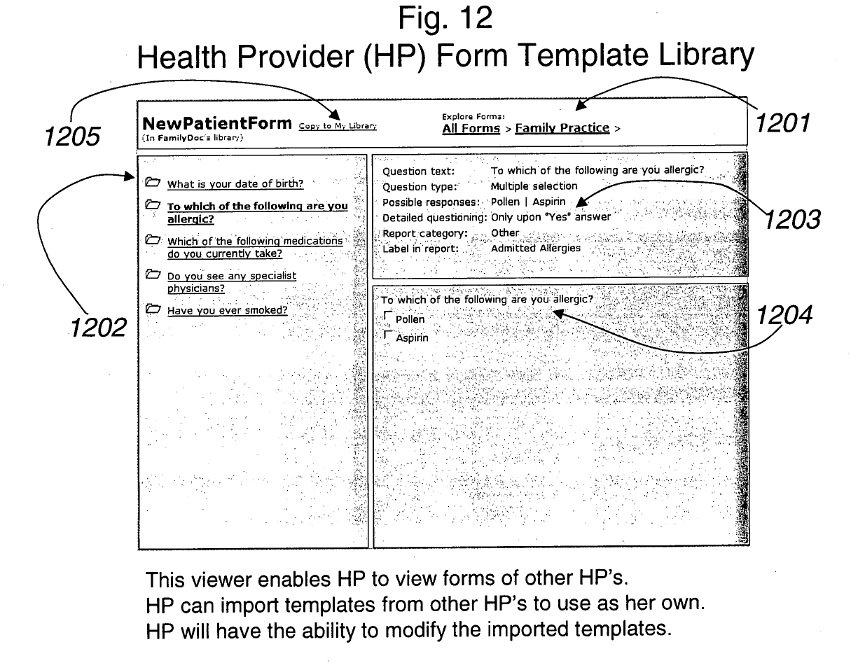

FIG. 12 illustrates a Health Provider (HP) Form Template Library. The present systems and methods enable the health provider to view forms from other participating health provider appropriately archived 1201. The library can be configured so that the form creator can make his forms available, unavailable, or available for compensation. The health provider can then acquire the viewed template 1205. The present systems and methods enable health providers to preview the questions 1202, selected question 1204, and features of selected question 1203.

The health provider interface can also enable a health provider to review the marketing presentation to be provided to the health consumer. In this way, the health provider retains control over the information provided to his or her health consumers in the health provider's facility. The health provider interface can include a veto button. The health provider interface can include a means for adjusting the marketing presentation instead of or in addition to the means of accepting or rejecting the marketing presentation. For example, the health provider interface may permit the health practitioner to selectively delete or otherwise edit portions of the marketing presentation. The health provider interface can also permit the health practitioner to adjust the interface posed to the health consumer for obtaining health data and/or the paper form containing the obtained health data generated by the systems or methods. The present methods and systems can include means for performing one or more of those functions.

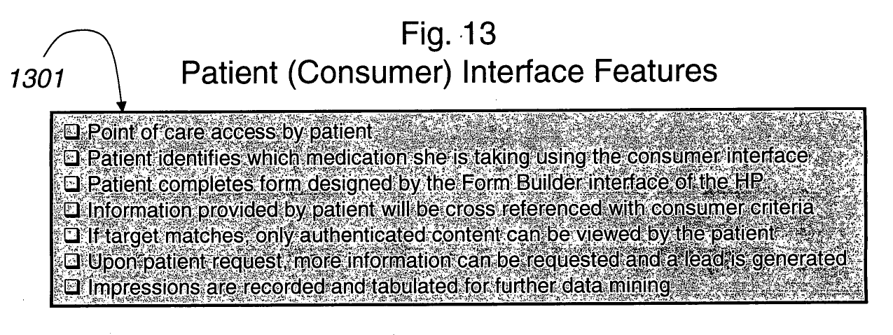

FIG. 13 shows features of a Patient (health consumer) Interface. With the present systems and methods, the patient will have the ability to perform such features 1301 point of care access, identification of medications taking, view authenticated content, request more information regarding a product or service. The patient interface presents the interview to the patient, through which the health data is obtained.

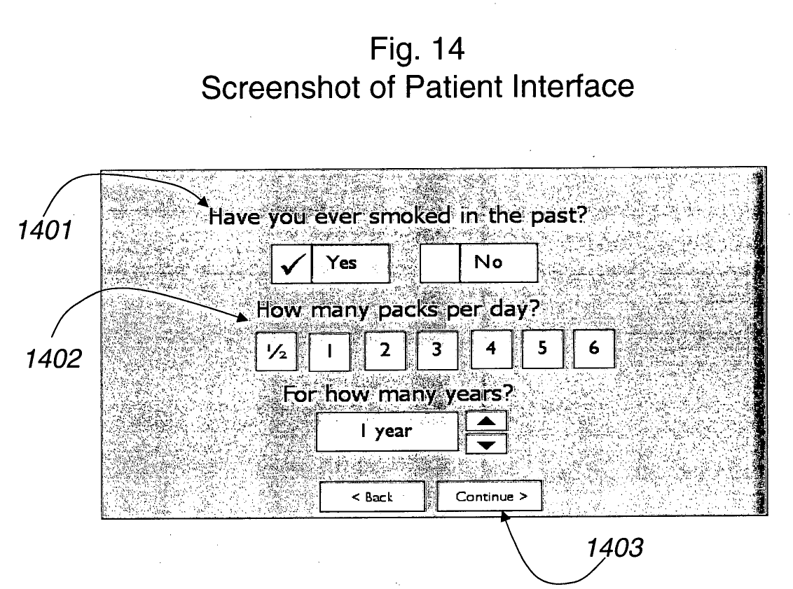

FIG. 14 shows an example of a health consumer interface. The question 1401 will have the ability to request more pertinent information 1402 if the prior question 1401 fulfills preprogrammed criteria. Once complete the patient can move on to the next step as indicated, for example, by the continue button 1403. The health consumer interface need not take the exact form of FIG. 14. It is preferred that the health consumer interface have one or more of the following characteristics: (1) Input controls made large in order to simplify pen or touch input by the health consumers. For the same reason, ample space between controls to reduce input mistakes. (2) Incorporating significant color contrast, clear and readable type, a large-type option, and to accommodate those with difficulty seeing or those who are color-blind. (3) The interface design provide visual feedback. Health consumer input can be acknowledged with appropriate visual effects.

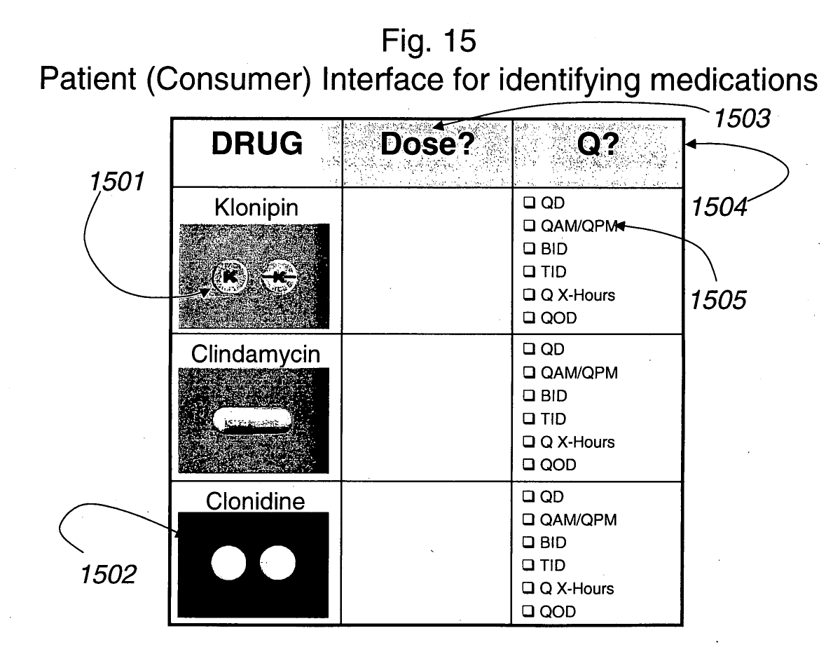

FIG. 15 shows a Patient (health consumer) Interface for Identifying Medications. The interface allows patients to identify medications based on drug name 1501 and images 1502. It is contemplated that the images 1502 will greatly aid the health consumer in correctly identifying his or her medication. This can be of great benefit to the health provider as well, saving a physician or nurse significant time in helping a patient recall and correctly identify his or her medication. The dose 1503 can be identified by the patient by typing or writing the amount. How often the patient takes the medication can be identified 1505. The present systems and methods can be configured so that columns 1504 can be modified by the health provider and/or the system administrator.

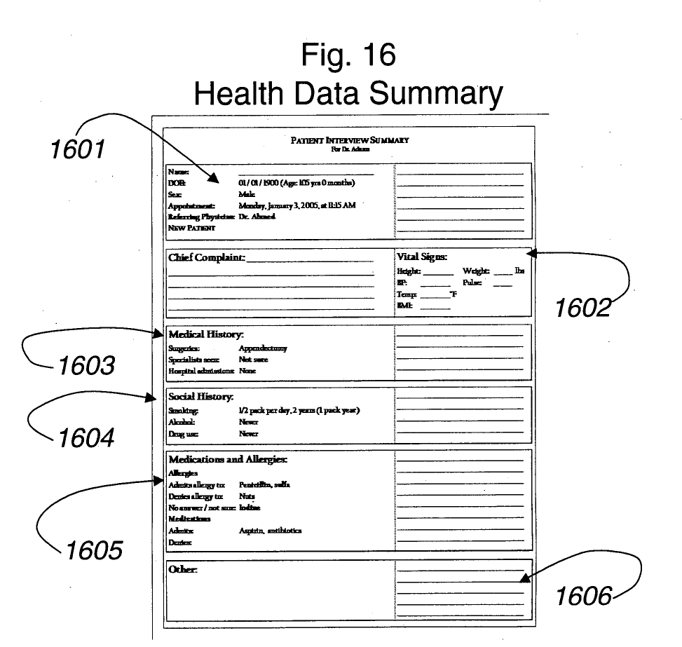

FIG. 16 shows an example of a paper record or form generated by the present systems and methods. FIG. 16 illustrates yet another advantage of the present systems and methods in providing an efficient way of formatting and presenting the obtained health data. The present systems and methods compiles health data and reformats it into a desired format. Biographic information, for example, is reformatted and viewable in the corresponding location 1601. Health history information, for example, is reformatted and viewable in the corresponding location 1603. Social history information, for example, is reformatted and viewable in the corresponding location 1604. Medication information, for example, is reformatted and viewable in the corresponding location 1605. Vital signs can be noted in the corresponding location 1602. Blank spaces 1606 are provided to note any information. When the health consumer finishes answering all the questions, a paper can be automatically generated with the pertinent health data. The configuration of the can be preformatted by the physician to meet the customized needs of her practice style. This can be printed out at the nursing station. Subsequently it can be used by the physician during his or her evaluation of the health consumer in the exam room.

FIG. 17 shows desirable features 1701 of a Pharmacy (Rx) Vendor Interface (or interface for any vendor of health products or services). The present systems and methods can be configured to provide a pharmacy vendor with the ability to perform actions such as remotely uploading inventory with corresponding prices. Vendor products will be appropriately matched with their corresponding image, and the vendor can provide appropriate collateral information such as shipping options, insurance options, pricing, and pickup location(s).

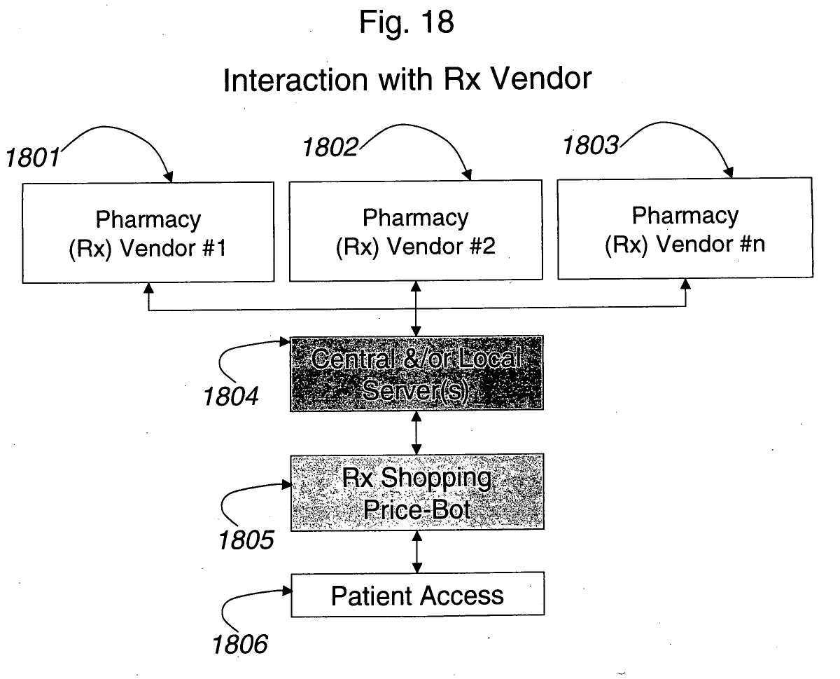

FIG. 18 shows an interaction between the present systems and methods with a vendor. The present systems and methods can allow for separate systems to communicate. Pharmacy vendors, such as vendor #1 1801, vendor #2 1802, vendor #n 1803 can provide the central and/or local server(s) 1804 with the appropriate information. This information is then adjusted to fit the parameters of the Rx Shopping Price-Bot 1805 which then can be accessed by patients 1806 or consumers.

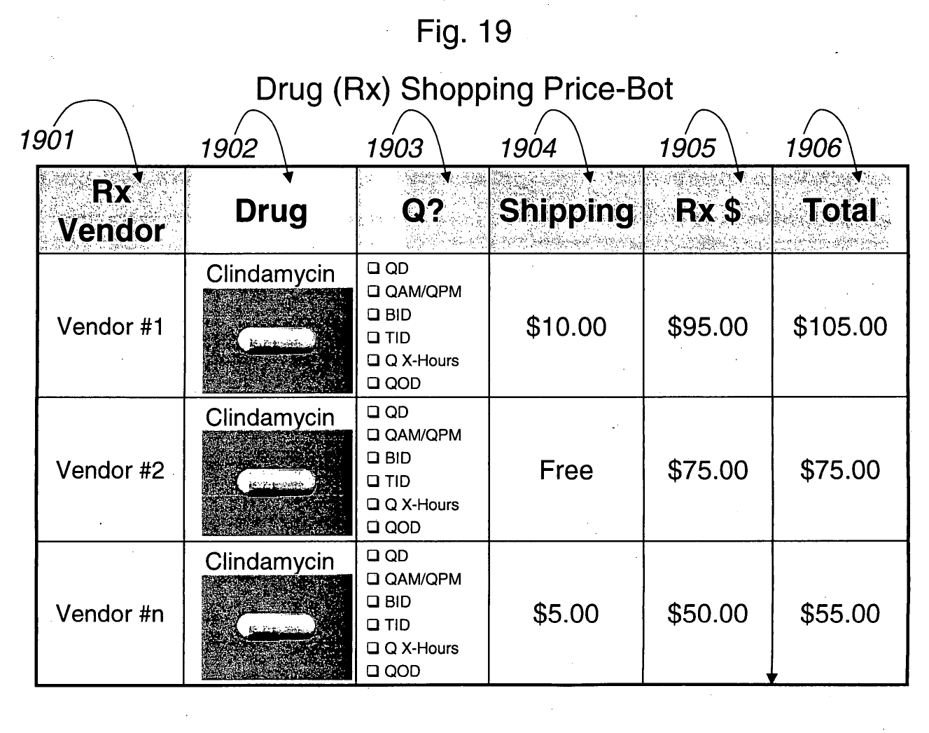

FIG. 19 illustrates the output of a drug (Rx) shopping price-bot which is provided in some embodiments of the present systems and methods. The Rx shopping price-bot allows RX vendors 1901 to display their products such as drugs 1902 for sale with the corresponding shipping 1904, product price 1905, dosage frequency 1903, and total price 1906 information. This enables health consumers to purchase medications on-line, before they leave the physicians office.

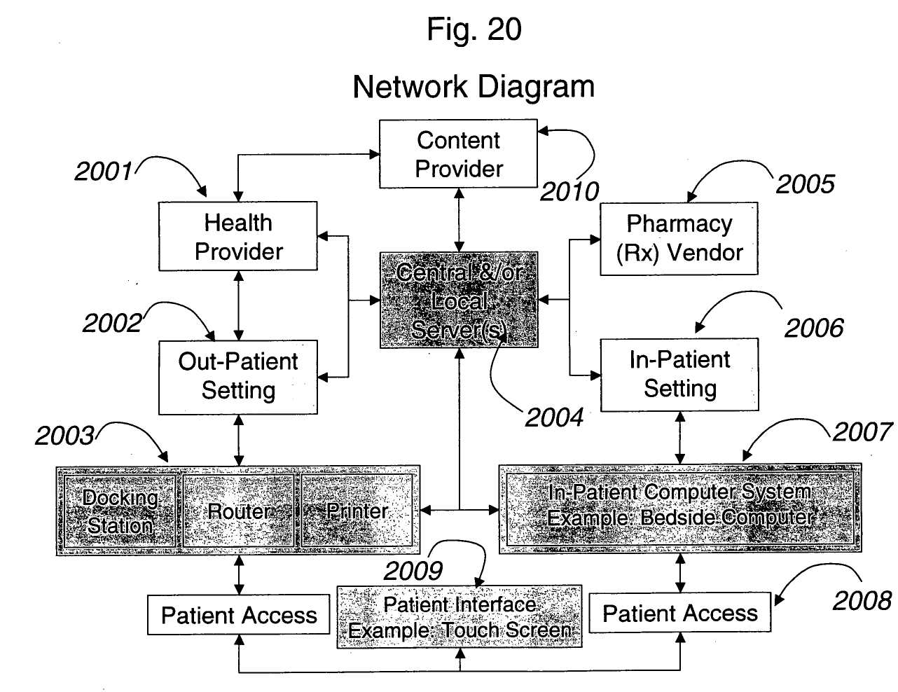

FIG. 20 shows a network diagram. The central or local server(s) 2004 coordinates information between the content provider 2010, health provider 2001, Rx vendor 2005, and the patient 2008. The present systems and methods can exchange information with separate process and systems in various environments including the out-patient setting 2002 and the in-patient setting 2007. The patient can use the present systems and methods with interfaces provided by a touchscreen computer 2009. Information can then be managed by the process and system adopted such as the In-Patient computer system 2007 or the Out-Patient Network 2003. Information from these systems can then be exchanged with the central or local server(s) 2004.

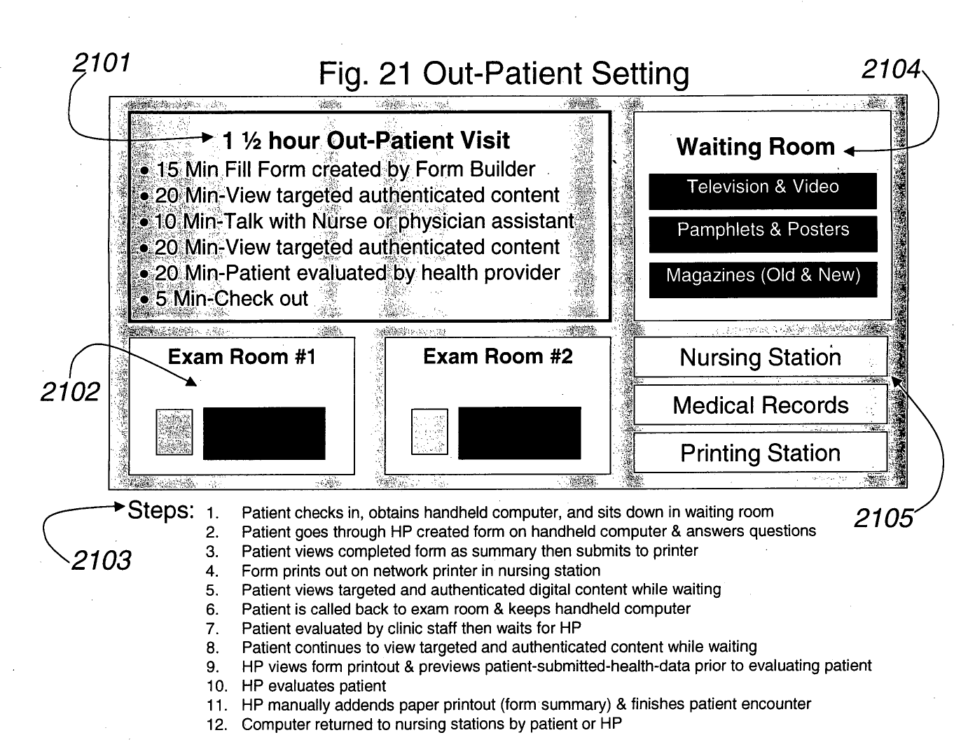

FIG. 21 illustrates the present systems and methods in an out-patient setting. The out-patient environment is a potential setting of the present systems and methods. A patient for example, will spend some time at the out-patient location 2101. While patients are waiting in the waiting room 2104, their options have traditionally been limited to watching television or looping videos, and reading pamphlets, posters, magazines, and newspapers. The present systems and methods provide a new and useful option for such patients, one which leverages waiting time for the benefit of both patients and physicians. The present systems and methods can, for example, adopt the following flow 2103: The patient checks in, grabs handheld computer, and sits down in waiting room 2104, patient goes through health provider approved interview on the handheld computer and answers questions, patient views completed the interview as summary (FIG. 16) then submits to printer, a form prints out on network printer in nursing station 2105, patient continues to view targeted marketing presentations previously approved by the physician while waiting, patient is called back to exam room 2102 and keeps handheld computer, patient evaluated by clinic staff in exam room 2102 then waits for health provider, patient continues to view targeted and authenticated content while waiting, health provider views form printout (FIG. 16) prior to evaluating patient, health provider evaluates patient, health provider manually addends form summary and finishes patient encounter, computer returned to nursing station 2105 by patient or health provider.

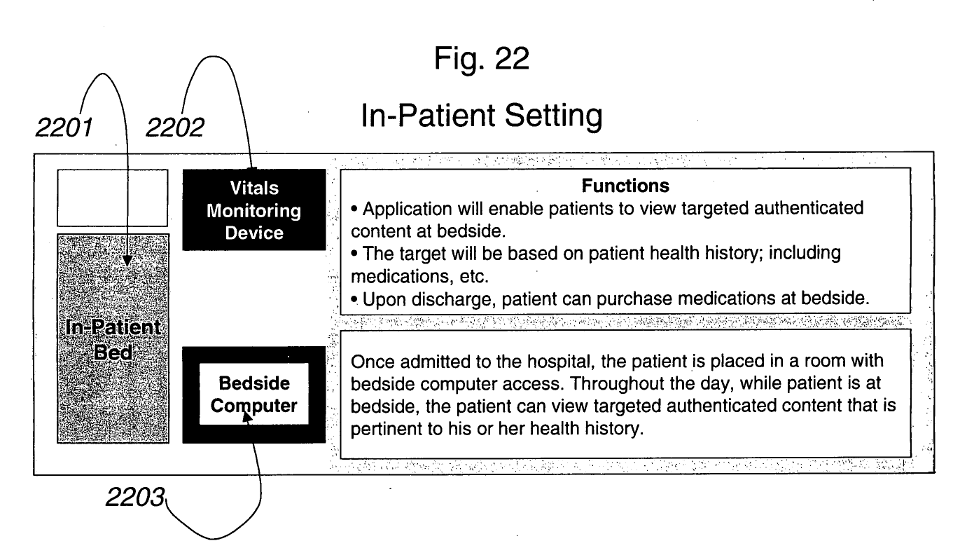

FIG. 22 shows the use of the present systems and methods in an in-patient setting. The patient in his or her bed 2201 will have the ability to access a bedside computer 2203, for example, that can enable patients to view targeted and authenticated content that is based on pertinent criteria. Upon discharge, the patient can purchase medications at bedside using the present systems and methods.

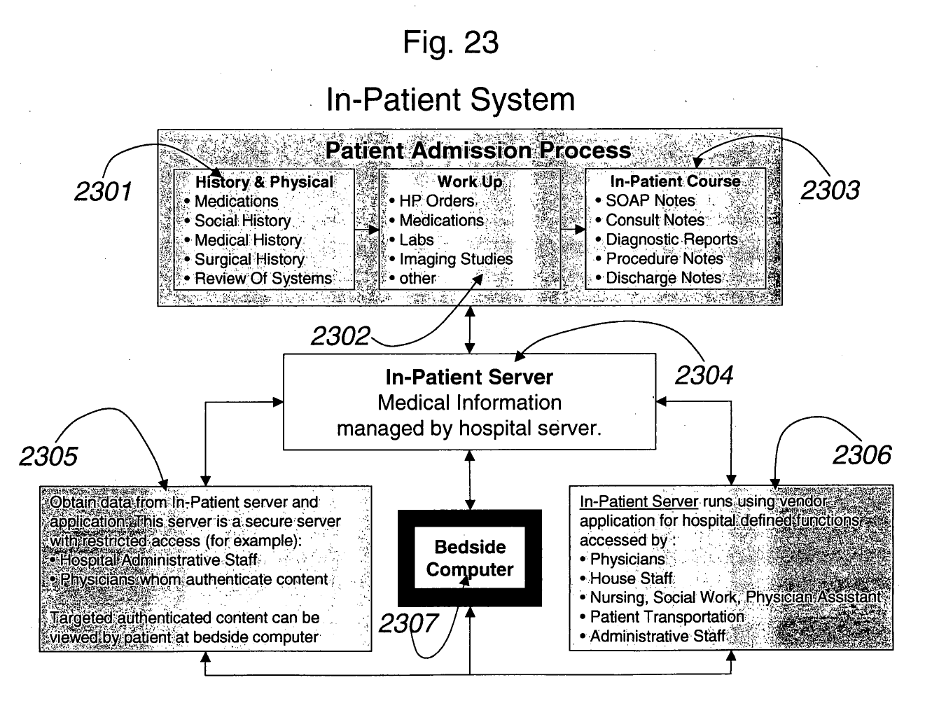

FIG. 23 illustrates the interaction of the present systems and methods with an in-patient system. The patient admission process into an in-patient setting can include such functions as obtaining a patient history and physical 2301 and a patient work-up 2302. The history and physical 2301 can include information such as patient medications, patient social history, patient medical history, patient surgical history, and review of systems. The work-up 2302 can include information such as health provider orders, medications ordered, labs ordered, imaging studies ordered. While the patient is in the in-patient setting certain activities will document the patient's in-patient course 2303. The in-patient course 2303 can include information such as SOAP notes, consult notes, diagnostic reports, procedure notes, and discharge notes. The in-patient server 2306 can be accessed, for example, by physicians, house staff, nursing, social workers, physician assistants, patient transportation, and administrative staff. The in-patient server 2304 can be accessed at various locations including but not limited to office computers, nursing stations computers, or patient bedside computer 2307. Data can be obtained 2305 by interacting with the in-patient server 2304 to appropriately target authenticated content to the patient or consumer at various locations including the bedside computer 2307.

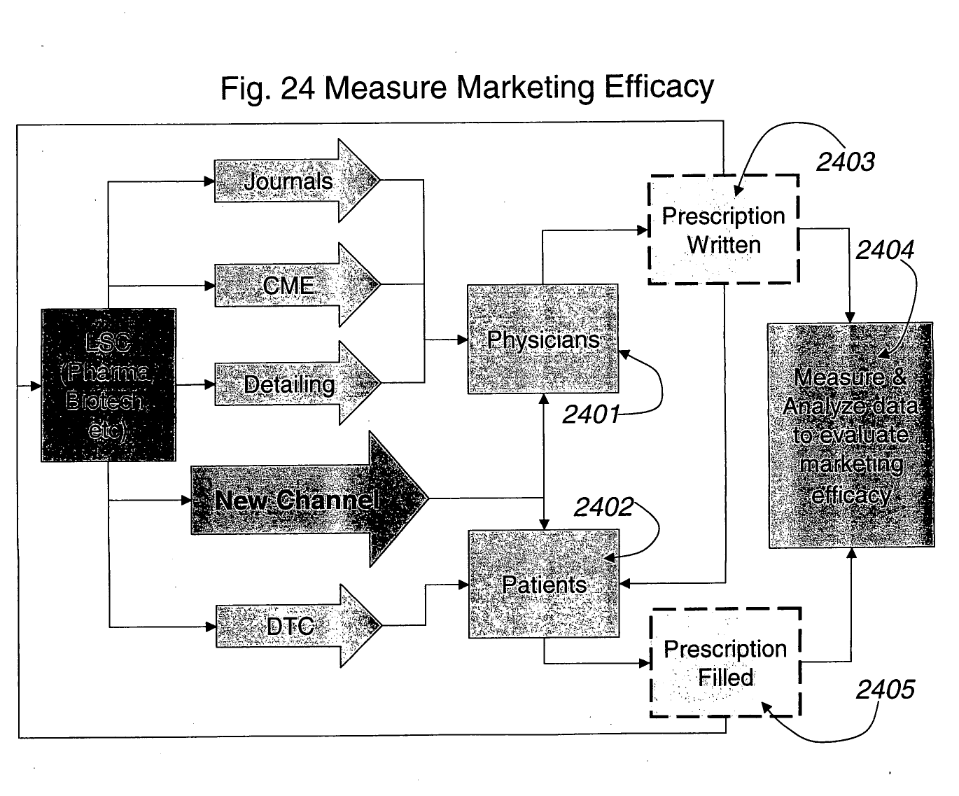

FIG. 24 illustrates that the present systems and methods can be used to measure the efficacy of marketing presentations. The present systems and methods can provide a means or module configured to measure the efficacy of marketing presentations by obtaining and assessing prescription information and/or purchasing information. For example, the present methods and systems can be used to obtain certain data such as prescriptions written 2403 or prescriptions filled 2405. This data can be associated with a tracking number for the health consumer. Other data that can be associated with the tracking number includes health data and health provider data. This information can be analyzed with respect to marketing channels that target such groups as physicians 2401 and patients 2402. The data collected can then be assessed 2404 such as by determining whether correlations exist or the strength of those correlations.

Persons skilled in the art can, using the preceding description, make and use the present systems and methods but the following examples are provided to further illustrate the present systems and methods. The following examples are not intended to limit the scope of the invention or the claims.

### EXAMPLE 1

An initial example of the present methods and systems is described in the context of a health consumer seeking treatment from a health provider. The health provider may be a general practitioner or a specialist. At the initial and subsequent visits by the health consumer, health data is obtained from the health consumer, including personal information, social history and past medical history. Among the advantages of the present processes and apparatus are that an electronic medical record can be created at the initial visit by the health consumer, and on subsequent visits, the health consumer only needs to enter health data that has changed, rather than completing a form with the same data that was previously obtained.

Health data is typically obtained through an interview using questions designed to obtain data that is important to the health provider. In the present systems and methods, the interview can be conducted using a handheld electronic tablet with a touchscreen. For example, a health consumer can be asked the questions below which appear on the touch screen, and the health consumer answers by checking a box where appropriate, or by typing the answers. Some computers may permit the health consumer to answer by writing on the screen or by speaking (to a computer with voice-recognition capability).

The precise wording of the questions is not considered critical, so long as the question accurately elicits the desired health data. Another advantage of some embodiments of the present systems and methods is the capability for the health provider to pick the wording she prefers, and/or to add or delete questions from the interview. Another advantage of some embodiments of the present systems and methods is the capability for automatic translation of the questions in the language spoken by the health consumer. As a non-limiting example of an interview, the health consumer is asked the following questions:

| | |
|---|---|
| | What is your date of birth? |
| | What is your gender? □ Male □ Female |
| | What is your ethnicity (race)?: |
| □ | Caucasian |
| □ | African-American |
| □ | Hispanic |
| □ | Asian/Pacific |
| □ | Alaskan/Indian |
| □ | Other |
| | Do you smoke cigarettes, use smokeless tobacco, or use tobacco |

in any form? □ Yes □ No If yes, how often?

Do you use alcohol? □ Yes □ No if yes, how often

and how much?

Has anyone ever told you to cut down on your drinking?

□ Yes □ No

Have you ever used/tried marijuana, cocaine, or any other illicit

“street” drugs? □ Yes □ No If yes, please identify them.

Do you drink caffeinated beverages? □ Yes □ No If yes,

how often and how much?

Do you feel stressed out? □ Yes □ No If yes, do you feel as

though you get the necessary support to deal with your stress?

Have you had a weight change (loss or gain) of greater than 10

pounds in the past year? □ Yes □ No

Do you exercise regularly? □ Yes □ No If yes, what type of

exercise? Amount per week?

Do you get enough sleep at night? □ Yes □ No How many

hours of sleep do you get at night?

Do you wake up feeling rested? □ Yes □ No

Additional questions may be asked to obtain health data about past medical history, family medical history, current medications, systems review, chief complaints, employment or environmental information, insurance information, injury causation, and/or other health data of interest to the health provider. The answers provided by the health consumer comprise obtained health data, which is then printed on a form such as that shown in FIG. 16.

### EXAMPLE 2

Another example of the present systems and methods is described in the context where one or more marketing presentations are selected based on health data obtained in Example 1. More particularly, one or more marketing presentations are selected based on the health consumer's gender, ethnicity and/or age.

The obtained health data includes the health consumer's gender, and one or more marketing presentations can be selected based on gender. For example, if the health consumer is male, a marketing presentation about prostate specific antigen (PSA) tests for prostate cancer can be selected, and a marketing presentation about mammograms would not be selected. If the health consumer is female, the opposite selection is made. In this way, marketing presentations are targeted to appropriate health consumers with the more appropriate marketing presentation shown to both male and female health consumers. The selection can be additionally based upon the health consumer's ethnicity and/or age. For example, African-American males have a greater risk of prostate cancer at an earlier age, so a marketing presentation about PSA tests may be selected for African-American males over 40 years of age and for Caucasian males over 50 years of age. For Caucasian males over 40 and under 50 years of age, a marketing presentation other than PSA tests (for example, about treatments for heart disease) may be selected and provided to the health consumer, either instead of or before a marketing presentation about PSA tests.

### EXAMPLE 3

Another example of the present systems and methods is described in the context of a health consumer seeking treatment from a health provider. A health consumer suffering from one or more symptoms of an illness enters a physician office. The method comprises obtaining health data from a health consumer, including whether the health consumer is allergic to any medications. For example, an interview may ask whether the health consumer is allergic to penicillin and/or antibiotics.

A marketing presentation can be selected based on the allergies to medications reported by the health consumer. The health consumer's allergies to medications (particularly to penicillin) are frequently obtained as health data. For example, if the interview indicates that the health consumer is allergic to penicillin, one or more marketing presentations for erythromycin or another medication suitable for penicillin-allergic patients is selected and presented to the health consumer. Marketing presentations of penicillin-based antibiotics would not be selected. If the obtained health data indicated that the health consumer was not allergic to penicillin, one or more marketing presentations for penicillin-based antibiotics would be selected.

### EXAMPLE 4

Another example of the present systems and methods is described in the context of a health consumer seeking treatment for allergy and/or seeking treatment from a health practitioner specializing as an allergist. A health consumer suffering from one or more symptoms of an allergy enters a health provider's office. General health data is obtained from a health consumer, such as by asking the interview questions of Example 1. More specific health data is obtained from a health consumer by asking one or more of the following questions relevant to an allergist:

| | |
|---|---|
| | What problems do you want evaluated? (check) |
| □ | Hay fever or nasal problems |
| □ | Eye symptoms |
| □ | Sinus and/or Ear problems |
| □ | Breathing difficulties (Asthma, bronchitis, cough, etc.) |
| □ | Skin problems (Hives or swelling, eczema, or other rash) |
| □ | Insect reaction (local swelling) |
| □ | Drug reaction |
| □ | Food reaction |
| □ | Headaches |
| □ | Other |
| | What nasal symptoms do you have? |
| □ | nasal discharge - clear, yellow, green |
| □ | post nasal drip |
| □ | sneezing |
| □ | nasal itchiness |
| □ | nasal congestion |
| □ | frequent nose blowing |
| □ | loss of smell/taste |
| □ | throat itchiness |
| | What sinus symptoms do you have? |
| □ | frequent sinus infections |
| □ | facial pain and tenderness |
| □ | tooth pain |
| □ | pressure and congestion |
| □ | colored nasal discharge |
| □ | headaches |
| | What chest symptoms do you have? |
| □ | cough, wheeze, shortness of breath; If yes, how long? |

how often ?

| | |
|---|---|
| □ | chest tightness |
| □ | waking up at night |
| | how many nights per week? |
| | do you cough up anything? What color? |
| | have you tried any inhalers or albuterol? |
| | do you have a nebulizer or breathing machine? |
| | do you have a peak flow meter? |
| | how many severe episodes in the last year? |
| | have you used prednisone or oral steroids? |
| | have you been to the emergency room? |
| | have been hospitalized for the chest symptoms? |
| | When? |
| | do you have stomach reflux? |
| | do you have problems with exercise? |
| | What eye symptoms do you have? |
| □ | itchiness, redness, puffiness |
| □ | watery discharge□ |
| □ | eyelid irritation |
| □ | dark circles under eyes |

do you use eye drops? □ Yes □ No

| | |
|---|---|
| | What skin symptoms do you have? |
| □ | hives, welts, red patches, itchiness |
| □ | eczema |
| □ | areas of swelling |
| | how long? |
| | family history of swelling or eczema? □ Yes □ No |
| | recent infection? □ Yes □ No |
| | recent antibiotic use? □ Yes □ No |
| | Do any of these allergens trigger your symptoms? (Check each |

symptom, and check N for nasal and/or C for chest)

| | | |
|---|---|---|
| □ pollens (grass, weeds, trees) | N □ | C □ |
| □ animals (cat, dog, horse) | N □ | C □ |
| □ mold/mildew | N □ | C □ |
| □ dust | N □ | C □ |
| □ foods | N □ | C □ |

Do any of these infections trigger your symptoms? (Check each

symptom, and check N for nasal and/or C for chest)

| | | |
|---|---|---|
| □ viral colds | N □ | C □ |
| □ sinus infection | N □ | C □ |

Do any of these trigger your symptoms? (Check each symptom,

and check N for nasal and/or C for chest)

| | | |
|---|---|---|
| □ antibiotics | N □ | C □ |
| □ aspirin | N □ | C □ |
| □ chemicals | N □ | C □ |
| □ insects | N □ | C □ |
| □ emotions | N □ | C □ |
| □ stress | N □ | C □ |
| □ laughter | N □ | C □ |
| □ crying | N □ | C □ |
| □ Other | | |

Do any of these irritants trigger your symptoms? (Check each

symptom, and check N for nasal and/or C for chest)

| | | |
|---|---|---|
| □ weather changes | N □ | C □ |
| □ wind | N □ | C □ |
| □ cold air/humidity | N □ | C □ |
| □ exercise | N □ | C □ |
| □ woodstove/fireplace | N □ | C □ |
| □ strong odors | N □ | C □ |
| □ perfumes/chemicals | N □ | C □ |
| □ tobacco smoke | N □ | C □ |

| CHECK WHICH MONTHS YOU HAVE SYMPTOMS | |
|---|---|
| Nose/Ears | JAN □ FEB □ MAR □ APR □ MAY □ JUN □ |
| | JUL □ AUG □ SEP □ OCT □ NOV □ DEC □ |
| Sinus | JAN □ FEB □ MAR □ APR □ MAY □ JUN □ |
| | JUL □ AUG □ SEP □ OCT □ NOV □ DEC □ |
| Breathing | JAN □ FEB □ MAR □ APR □ MAY □ JUN □ |
| | JUL □ AUG □ SEP □ OCT □ NOV □ DEC □ |
| Skin | JAN □ FEB □ MAR □ APR □ MAY □ JUN □ |
| | JUL □ AUG □ SEP □ OCT □ NOV □ DEC □ |

CURRENT MEDICATIONS (List medicines taken for any

reason including aspirin, blood pressure, thyroid, nose sprays, etc.)

Name of medication
Dose
How often taken
Additional medications □ Yes □ No (If YES, the

above questions are asked again.)

| PRIOR ALLERGIC REACTIONS | |
|---|---|
| Drug Reaction: | |
| Medication: | |
| Reaction: | |
| Symptoms: | |
| □ | tongue or throat swelling |
| □ | hives |
| □ | shortness of breath |
| □ | wheeze |
| □ | local swelling |

Additional Drug Reactions? □ Yes □ No (If yes, the

above questions are asked again.)

| | Insect Reaction: |
|---|---|
| Insect type: | |
| Reaction: | |
| When did this occur? | |
| Symptoms of Insect Reaction: | |
| □ | tongue or throat swelling |
| □ | hives |
| □ | shortness of breath |
| □ | wheeze |
| □ | local swelling |

Additional Insect Reactions? □ Yes □ No (If yes, the

above questions are asked again.)

Food Reaction: □ Yes □ No (If yes, the above questions

are asked again.)

| What were you eating? | |
|---|---|
| Time from eating to onset of reaction? | |
| Symptoms of Food Reaction: | |
| □ | tongue or throat swelling |
| □ | hives |
| □ | nausea |
| □ | vomiting |
| □ | diarrhea |
| □ | shortness of breath |
| □ | wheeze |

Additional Food Reactions? □ Yes □ No (If yes, the

above questions are asked again.)

The health data obtained in the interview is used to select one or more marketing presentations about health products and/or health services for allergies. One or more marketing presentations can be presented about medications for treating allergies. For example, the marketing presentation(s) can be selected based on one or more of (a) health consumer age; (b) health consumer gender; (c) geography; (d) specialty or subspecialty of the health provider; (e) one or more health products taken by the health consumer; (f) one or more allergy symptoms of the health consumer; (g) the months when the health consumer has symptoms; (h) prior allergic reactions of the health consumer; (i) symptom triggers for the health consumer; (j) whether the health consumer experiences indoor allergies, outdoor allergies or both; (k) one or more diagnoses of the health consumer; and/or (I) health consumer tobacco use.

The health data can be used to select a class of allergy medication (for example, antihistamines, antihistmine-decongestant combinations, antihistmine-decongestant-pain reliever combinations, decongestants, eye drops, or nasal sprays), and a marketing presentation(s) can be selected from a selected type of allergy medication. Alternatively or additionally, the health data can be used to select a marketing presentation(s) about a specific allergy medication (for example, ZYRTEC, CLARINEX, CLARITIN, ALLEGRA, FLONASE, BENADRYL, TAVIST D, SUDAFED, CHLOR-TRIMETON, VISINE,). Alternatively or additionally, the health data can be used to select a marketing presentation(s) about a prescription allergy medication (for example, ZYRTEC, CLARINEX, ALLEGRA, FLONASE). or an over-the-counter allergy medication. (for example, BENADRYL, SUDAFED, CLARITIN, CHLOR-TRIMETON, TAVIST D). Alternatively or additionally, marketing presentations about health products and/or services available in clinical trials or as experimental therapies for treating allergies can be presented.

A marketing presentation can be selected based on one or more symptoms reported by the health consumer. For example, if the interview indicates that the health consumer experiences both indoor and outdoor allergies, a marketing presentation for a medication effective for treating both indoor and outdoor allergies is selected and presented to the health consumer. As another example, if the interview indicates that the health consumer experiences indoor allergies exclusively or primarily, a marketing presentation for a medication effective for treating indoor allergies is selected and presented to the health consumer. As another example, if the interview indicates that the health consumer experiences outdoor allergies exclusively or primarily, a marketing presentation for a medication effective for treating outdoor allergies is selected and presented to the health consumer.

Using the health data obtained from the health consumer and optionally data about the health provider, it is possible to provide targeted marketing presentations about health products and/or services for allergies to the health consumer and optionally the health provider.

### EXAMPLE 6

Another example of the present systems and methods is described in the context of a health consumer seeking treatment for back pain. A health consumer suffering from back pain enters a health provider's office. General health data is obtained from health consumer, such as by asking the interview questions of Example 1. More specific health data is obtained from health consumer by asking one or more of the following questions relevant to back pain:

| | |
|---|---|
| | Mechanism of pain onset: |
| □ | Suddenly |
| □ | Gradually |
| □ | Lifting |
| □ | Twisting |
| □ | Fall |
| □ | Bending |
| □ | Pulling |
| □ | Injured at Work |
| □ | Auto Accident |
| □ | Hit in Back |
| □ | Sports |
| □ | No Apparent Cause |
| | What activities make the pain worse? |
| □ | During Exercise |
| □ | After Exercise |
| □ | Sitting |
| □ | Standing |
| □ | Walking |
| □ | Bending Forward |
| □ | Bending Backward |
| □ | Coughing |
| □ | Sneezing |
| | What reduces your pain? |
| □ | Lying Down |
| □ | Sitting |
| □ | Standing |
| □ | Walking |
| □ | Manipulation |
| □ | Physical Therapy |
| □ | Pain Pills |
| □ | Muscle Relaxants |
| □ | Aspirin |
| □ | Other |
| □ | Nothing |
| | How long have you had any back pain? |

years months weeks

How long have you had any leg pain?

years months weeks

How long have you had any neck pain?

years months weeks

How long have you had any arm pain?

years months weeks

Have you had any diagnostic studies other than by x-rays?

□ Yes □ No
If yes, what was the date?

Have you had a CAT scan? □ Yes □ No

If yes, what was the date?

Have you had a myelogram? □ Yes □ No

If yes, what was the date?

Have you had an EMG? □ Yes □ No

If yes, what was the date?

Have you had a discogram? □ Yes □ No

If yes, what was the date?

Have you had an MRI? □ Yes □ No

If yes, what was the date?

Have you been in the hospital for your back problem?

□ Yes □ No
If yes, number of times: date:

Are there any recent changes in bowel or bladder habits?

□ Yes □ No
If yes, describe:

Have you had neck or back surgery? □ Yes □ No

If yes, number of times: describe:

The health data obtained in the interview is used to select one or more marketing presentations about health products and/or health services for back pain. One or more marketing presentations can be presented about medications for treating back pain. For example, the marketing presentation(s) can be selected based on one or more of (a) geography, (b) health consumer age; (c) health consumer gender; (d) specialty or subspecialty of the health provider; (e) one or more health products taken by the health consumer; (f) one or more symptoms of the health consumer; (g) one or more diagnoses of the health consumer; (h) mechanism of onset of back pain; (i) activities that make pain worse; and/or (j) what reduces the pain.

The health data can be used to select a type of pain medication (such as acetaminophen, NSAIDs such as aspirin, ibuprofen, and COX-2 inhibitors, narcotic pain medications, muscle relaxants, oral steroids, other non-narcotic pain medications, antidepressants, anti-seizure medications (such as neuroleptic drugs), osteoporosis medications, anti-smoking medications, tranquilizers, and stimulants. Alternatively or additionally, the health data can be used to select a marketing presentation(s) about a specific pain medication (for example, MOTRIN, ADVIL, CELEBREX, BEXTRA, ULTRAM). Alternatively or additionally, the health data can be used to select a marketing presentation(s) about a prescription pain medication (for example, ULTRAM). or an over-the-counter allergy medication (for example, MOTRIN, ADVIL). Alternatively or additionally, marketing presentations about health products and/or services available in clinical trials or as experimental therapies for treating allergies can be presented. Alternatively or additionally, the marketing presentations can relate to health products and/or services such as injections (such as steroid injections or epidural injections), alcohol avoidance programs, physical therapy programs, chiropractic or osteopathic treatments, or braces.

A marketing presentation can be selected based on the symptoms reported by the health consumer. For example, if the health data indicates that the health consumer has stomach or intestinal problems (such as disease or discomfort), a marketing presentation(s) for a COX-2 inhibitor is selected and presented to the health consumer, and a marketing presentation for aspirin is not selected or presented. As another example, if the health data indicates that the health consumer does not have stomach or intestinal problems, a marketing presentation that discusses the benefits of aspirin or ibuprofen over COX-2 inhibitors may be selected.

Using the health data obtained from the health consumer and optionally data about the health provider, it is possible to provide targeted marketing presentations about health products and/or services for back pain to the health consumer and optionally the health provider.

### EXAMPLE 7

Another example of the present systems and methods is described in the context of a health consumer seeking healthcare. A health consumer in a physician office or an in-patient facility is provided with interview questions via a handheld electronic tablet. Health data is obtained from a health consumer, including whether the health consumer's age and gender, whether the health consumer has a family history of colon cancer (both men and women over 50 years) and whether the health consumer has anemia.

A marketing presentation can be selected based on the health consumer's age and gender, whether the health consumer has a family history of colon cancer and age. For example, if the interview indicates that the health consumer is over 50 years of age but has no family history of colon cancer (and therefore may be unlikely to seek colon cancer screening in the absence of a marketing presentation about colon cancer screening), a marketing presentation for health services comprising colon cancer screening can be selected. In this situation, the health data indicates that this health consumer is less of a marketing target due to lower risk of colon cancer as compared to an individual with a family history of colon cancer (which increases risk of colon cancer). If the interview indicates that the health consumer is over 50 years of age and has a family history of colon cancer (and therefore is highly likely to be undergoing colon cancer screening, regardless of whether the health consumer is provided a marketing presentation for colon cancer screening), a marketing presentation for particular health products and/or services involved in colon cancer screening can be selected. In this situation, the health data indicates that the health consumer is of particular marketing interest for health products and/or services for use in colonoscopic due to his or her increased risk of colon cancer. For example, marketing presentations about colonoscopes having lower risk of perforation or about virtual colonoscopy can be selected.

### EXAMPLE 8

Another example of the present systems and methods is described in the context of a female patient just before or just after delivering a baby at an in-patient facility. The female patient at the in-patient facility is provided with interview questions via a bedside computer. Health data is obtained from the pregnant patient or new mother, including her home zip code.

A marketing presentation can be selected based on the patient's home zip code. For example, marketing presentations for pediatric services can be targeted based on the patient's home zip code.

In the present specification, use of the singular includes the plural except where specifically indicated. In the present specification, any of the functions recited herein may be performed by one or more means for performing such functions. The present systems and methods may include various means, modules, code segments, computer programs and/or software for performing one or more of the steps or actions described in this specification. It is expressly contemplated and disclosed that the present specification provides a written description for claims comprising such means, modules, code segments, computer programs and/or software.

All patents, test procedures, and other documents cited herein are fully incorporated by reference to the extent such disclosure is not inconsistent with this invention and for all jurisdictions in which such incorporation is permitted.

While the present invention has been described and illustrated by reference to particular embodiments, it will be appreciated by those of ordinary skill in the art that the invention lends itself to many different variations not illustrated herein. For these reasons, then, reference should be made solely to the appended claims for purposes of determining the true scope of the present invention.

Although the dependent claims have single dependencies in accordance with U.S. patent practice, each of the features in any of the dependent claims can be combined with each of the features of other dependent claims or the main claim.

I claim:

1. A method of providing one or more marketing presentations about health products or health services in an electronic format to a health consumer, the method comprising:
obtaining health data from the health consumer;
selecting the marketing presentation based on health data and optionally health provider data; and
providing the selected marketing presentation to the health consumer in an electronic format.

2. The method of claim 1, wherein the health data is obtained via a handheld computer having a touch-screen interface.

3. The method of claim 2, wherein the health data is obtained by an electronic interview approved, customized or designed by the health provider.

4. The method of claim 2, wherein the health data is obtained by providing one or more images to a health consumer whereby the health consumer can identify a health product, health service, or a health condition based on one of the images.

5. The method of claim 1, further comprising the steps of printing a paper form containing at least some of the health data obtained from the health consumer and excluding from the paper form one or more questions to which the health consumer had no response.

6. The method of claim 1, wherein the marketing presentation is selected based on one or more of (a) geography, (b) specialty or subspecialty of the health provider; (c) one or more health products previously taken by the health consumer; (d) one or more symptoms of the health consumer; (e) one or more diagnoses of the health consumer; (f) health consumer age; (g) health consumer gender; or (h) health consumer tobacco use.

7. The method of claim 1, further comprising the step of providing the health provider with an ability to approve, customize or design the marketing presentation before the health consumer is provided the marketing presentation.

8. The method of claim 1, wherein the marketing presentation comprises a rich media format or flash format.

9. The method of claim 1, further comprising the steps of assigning a tracking code to the health consumer, and associating the marketing presentation provided to the health consumer with the tracking code.

10. The method of claim 9, further comprising the steps of obtaining prescription information for the health consumer, and associating the prescription information to the health consumer with the tracking code.

11. The method of claim 1, further comprising the step of obtaining a price for a medication from one or more pharmacies.

12. The method of claim 1, further comprising the step of tracking transmission of a prescription to a pharmacy.

13. A system for providing one or more marketing presentations about health products or health services in an electronic format to a health consumer, the system comprising:
a health data collection module configured to obtain health data from a health consumer;
a selection module configured to select one or more marketing presentations about health products or health services for the health consumer, based on one or both of the health data and health provider data; and
a presentation module configured to present the selected marketing presentation.

14. The system of claim 13, further comprising:
a content management module configured to give access to the marketing presentation to an authorized content provider, wherein the authorized content provider can add, adjust, or remove the marketing presentation; and
a health provider approval module configured to give a health provider approval over the marketing presentation before the marketing presentation is available to the health consumer.

15. The system of claim 13, further comprising:
a tracking module configured to associate each marketing presentation to a health consumer with a tracking code.

16. The system of claim 15, wherein the tracking code does not identify the health consumer.

17. The system of claim 15, further comprising a reporting module configured to report tracking codes and information associated with the tracking codes to an authorized content provider.

18. The system of claim 17, further comprising a prescription request module, wherein the tracking module is configured to associate a prescription request with the tracking code.

19. The system of claim 13, further comprising: a translating module configured to translate one or both of the health data and the marketing presentation.

20. A system for providing one or more marketing presentations about a health product or service in an electronic format to a health consumer, comprising:
computer software adapted to obtain health data, select one or more marketing presentations based on the obtained health data, and provide the selected marketing presentation in an electronic format;
a computer adapted for running at least a portion of the computer software and presenting at least portion of the marketing presentation.

21. The system of claim 20, further comprising a printer adapted for communication with the computer and adapted for printing a paper record containing the health data obtained from the health consumer.

22. The system of claim 21, further comprising a local server configured to communicate with the computer and to store the marketing presentations.

23. The system of claim 22, further comprising a central server configured to communicate with the local server.

24. The system as set forth in claim 20, wherein the computer software comprises:
a code segment adapted to interview a health consumer for health data;
a code segment adapted to select, based on the health data, one or more marketing presentations about health products or health services;
a code segment adapted to provide the marketing presentations to the health consumer in electronic format.

25. A method of collecting information regarding prescriptions, the method comprising:
assigning a tracking code to a health consumer;
showing the health consumer one or more marketing presentations for a health product or service;
associating the marketing presentations shown to the health consumer with the tracking code;
determining whether the health consumer purchased one or more health products or health services or received a prescription for a medication, thereby obtaining purchase information or prescription information or both; and
associating the purchase information or prescription information or both with the tracking code.

26. The method of claim 25, further comprising one or both of the steps of:
associating one or more health conditions of the health consumer with the tracking code, and
associating one or more medications taken by the health consumer with the tracking code.

27. A health marketing system for providing a health consumer and a health provider with one or more marketing presentations about a health product or health service, the system comprising:
a central server configured to store one or more marketing presentations regarding health products or services
one or more local servers configured to communicate with the central server and to receive marketing presentations;
a health consumer interface configured to communicate with the local server,
a health provider interface that permits adjustment of the health consumer interface;
a content provider interface that permits a content provider to add, remove, or adjust the presentations for the health consumer interface;
wherein the health consumer interface is adapted to obtain health data;
wherein the local server is configured to receive health data from the health consumer interface and to select one or more marketing presentations about health products or health services based on the health data;
wherein the health consumer interface is adapted to present the selected marketing presentations in an electronic format.

28. The system of claim 27, wherein the health provider interface comprises an interview builder interface adapted for adding, removing, or adjusting interview questions in the health consumer interface.

29. The system of claim 27, wherein the content provider interface does not permit the content provider to view individually identifiable health information.
